(19) United States
(12) Patent Application Publication
(10) Pub. No.: US 2024/0208853 A1
(43) Pub. Date: Jun. 27, 2024

(54) OPTICAL GLASS AND OPTICAL ELEMENT

(71) Applicants: HOYA CORPORATION, Tokyo (JP); HOYA OPTICAL TECHNOLOGY (WEIHAI) CO., LTD., ShanDong (CN)

(72) Inventor: Keita SHIMADA, Tokyo (JP)

(73) Assignees: HOYA CORPORATION, Tokyo (JP); HOYA OPTICAL TECHNOLOGY (WEIHAI) CO., LTD., ShanDong (CN)

(21) Appl. No.: 18/394,293

(22) Filed: Dec. 22, 2023

(30) Foreign Application Priority Data
Dec. 27, 2022 (JP) 2022-209477

(51) Int. Cl. C03C 3/068

(52) U.S. Cl. CPC C03C 3/068

(57) ABSTRACT

The optical glass has, in mass %, SiO₂ content of 3.00% or more and 20.00% or less, B₂O₃ content of 1.00% or more and 18.00% or less, La₂O₃ content of 20.00% or more and 60.00% or less, Nb₂O₅ content of 8.80% or more, TiO₂ content of 5.00% or more and 20.00% or less, total content (MgO+CaO+SrO+BaO+ZnO) of 2.00% or more, mass ratio ((MgO+CaO+SrO+BaO+ZnO)/(SiO₂+B₂O₃)) of 0.300 or more, mass ratio ((Nb₂O₅+TiO₂+ZrO₂+WO₃)/(SiO₂+B₂O₃)) of 1.600 or more, mass ratio ((La₂O₃+Gd₂O₃+Y₂O₃)/(SiO₂+B₂O₃)) of 2.750 or more, mass ratio ((MgO+CaO+SrO+BaO+ZnO)/(Nb₂O₅+TiO₂+ZrO₂+WO₃)) of 0.290 or less, and mass ratio ((Nb₂O₅+TiO₂)/(SiO₂+B₂O₃)) of 1.400 or more.

### CROSS-REFERENCE TO RELATED APPLICATIONS

This application claims priority under 35 U.S.C 119 to Japanese Patent Application No. 2022-209477 filed on Dec. 27, 2022, which is hereby expressly incorporated by reference, in its entirety.

### TECHNICAL FIELD

The present disclosure relates to an optical glass and an optical element.

### BACKGROUND ART

In recent years, as the materials for an optical element, various optical glasses have been proposed (see, for example, Japanese Patent Application Publication No. 2015-91752, which is hereby expressly incorporated by reference, in its entirety).

### SUMMARY

As one of the properties desired for optical glass (which will be hereinafter also referred to as simply as “glass”), mention may be made of being excellent in devitrification resistance. For the devitrification resistance, for example, it can be said that the devitrification resistance at the time of reheating becomes more excellent with a decrease in thickness of the devitrified portion appearing on the glass surface layer after reheating the once vitrified glass (which will be hereinafter referred to as a “surface devitrified layer”). At the time of manufacturing an optical element, normally, the surface devitrified layer is removed by grinding. Therefore, the grinding amount can be more reduced with a decrease in thickness of the surface devitrified layer. For this reason, glass excellent in devitrification resistance is preferable from the viewpoint of yield improvement.

One aspect of the present disclosure provides for an optical glass excellent in devitrification resistance.

On aspect of the present disclosure relates to the following optical glass.

An optical glass, having, in terms of glass composition expressed in mass %,

a SiO₂ content of 3.00% or more and 20.00% or less,

a B₂O₃ content of 1.00% or more and 18.00% or less,

a La₂O₃ content of 20.00% or more and 60.00% or less,

a Nb₂O₅ content of 8.80% or more,

a TiO₂ content of 5.00% or more and 20.00% or less,

a total content of MgO, CaO, SrO, BaO, and ZnO (MgO+CaO+SrO+BaO+ZnO) of 2.00% or more,

a mass ratio of a total content of MgO, CaO, SrO, BaO, and ZnO to a total content of SiO₂ and B₂O₃ ((MgO+CaO+SrO+BaO+ZnO)/(SiO₂+B₂O₃)) of 0.300 or more,

a mass ratio of a total content of Nb₂O₅, TiO₂, ZrO₂, and WO₃ to a total content of SiO₂ and B₂O₃ ((Nb₂O₅+TiO₂+ZrO₂+WO₃)/(SiO₂+B₂O₃)) of 1.600 or more,

a mass ratio of a total content of La₂O₃, Gd₂O₃, and Y₂O₃ to a total content of SiO₂ and B₂O₃ ((La₂O₃+Gd₂O₃+Y₂O₃)/(SiO₂+B₂O₃)) of 2.750 or more,

a mass ratio of a total content of MgO, CaO, SrO, BaO, and ZnO to a total content of Nb₂O₅, TiO₂, ZrO₂, and WO₃ ((MgO+CaO+SrO+BaO+ZnO)/(Nb₂O₅+TiO₂+ZrO₂+WO₃)) of 0.290 or less, and

a mass ratio of a total content of Nb₂O₅ and TiO₂ to a total content of SiO₂ and B₂O₃ ((Nb₂O₅+TiO₂)/(SiO₂+B₂O₃)) of 1.400 or more.

The above optical glass can exhibit an excellent devitrification resistance by having the above glass composition. For example, the above optical glass can be an optical glass excellent in devitrification resistance at the time of reheating.

One aspect of the present disclosure can provide an optical glass excellent in devitrification resistance. Further, another aspect of the present disclosure can also provide an optical element including such optical glass.

### DESCRIPTION OF THE EMBODIMENTS

### [Optical Glass]

### <Glass Composition>

In the present disclosure and in the present specification, the glass composition of the optical glass is expressed in mass %. With the glass composition expressed in mass %, the glass composition is expressed in glass composition based on oxides. Herein, the term “glass composition based on oxides” represents the glass composition resulting from conversion based on the assumption that the glass raw materials are all decomposed upon melting to be present as oxides in the glass. With the glass composition expressed in mass %, the glass composition is expressed in terms of mass (mass %, mass ratio). Below, for the glass composition expressed in mass %, “mass %” will also be described simply as “%”.

In the present disclosure and in the present specification, the wording “the constituent component has a content of 0%, 0.0%, or 0.00%, or is not included, or is not introduced” means that the constituent component is substantially not included, and indicates that the content of the constituent component is approximately at an impurity level or less. The term “approximately an impurity level or less” means, for example, less than 0.01%. The term “0%” can mean, for example, “0.0%” or “0.00%”.

The glass composition in the present disclosure and in the present specification can be determined by, for example, the method such as ICP-AES (Inductively Coupled Plasma-Atomic Emission Spectrometry). For example, the quantitative analysis is performed separately for each element using ICP-AES. Subsequently, the analytical value is converted to the value expressed in terms of oxides. The analytical value by ICP-AES may include, for example, a measurement error of about ±5% of the analytical value. Therefore, the value expressed in terms of oxides converted from the analytical value may also similarly include an error of about ±5%.

In the present disclosure and in the present specification, the refractive index denotes a refractive index nd with a d line of helium (wavelength 587.56 nm).

In the present disclosure and in the present specification, the Abbe's number vd is used as the value indicating the property regarding dispersion, and is expressed by the following equation.

$$vd = ( nd - 1 ) / ( nF - nC )$$

In the equation, nF is the refractive index with the F line of blue hydrogen (wavelength 486.13 nm), and nC is the refractive index with the C line of red hydrogen (656.27 nm).

Below, the above optical glass will be further described in details.

The SiO₂ content is 3.00% or more, and can be 3.50% or more, 4.00% or more, 4.50% or more, 5.00% or more, 5.50% or more, and 6.00% or more from the viewpoints of the improvement of the thermal stability of glass and the improvement of devitrification resistance thereof. On the other hand, the SiO₂ content is 20.00% or less, and can be 19.50% or less, 19.00% or less, 18.50% or less, 18.00% or less, 17.50% or less, 17.00% or less, 16.50% or less, 16.00% or less, 15.50% or less, 15.00% or less, 14.50% or less, 14.00% or less, 13.50% or less, 13.00% or less, 12.50% or less, 12.00% or less, 11.50% or less, and 11.00% or less from the viewpoints of keeping the meltability of glass, keeping of the high refractive index thereof, and keeping of the devitrification resistance thereof.

B₂O₃ is a component capable of contributing to keeping the meltability of glass, reduction of the liquidus temperature, and attaining the lower dispersion thereof. The B₂O₃ content is 1.00% or more, and can be 2.00% or more, 3.00% or more, and 4.00% or more from the viewpoints of keeping the thermal stability of glass, keeping of the meltability of glass, and the reduction of the liquidus temperature thereof. On the other hand, from the viewpoint of keeping the chemical durability, the B₂O₃ content is 18.00% or less, and can be 17.00% or less, 16.00% or less, 15.00% or less, 14.00% or less, 13.00% or less, 12.00% or less, 11.00% or less, 10.00% or less, 9.00% or less, 8.00% or less, and 7.00% or less.

The total content of SiO₂ and B₂O₃ (SiO₂+B₂O₃) can be 5.00% or more and 25.00% or less from the viewpoints of the improvement of the thermal stability of glass and the further improvement of the devitrification resistance thereof. From the above viewpoints, the total content (SiO₂+B₂O₃) can be 6.00% or more, 7.00% or more, 8.00% or more, 9.00% or more, 10.00% or more, 11.00% or more, 12.00% or more, and 13.00% or more. Further, from the above viewpoints, the total content (SiO₂+B₂O₃) can be 24.00% or less, 23.00% or less, 22.00% or less, 21.00% or less, 20.00% or less, 19.00% or less, 18.00% or less, 17.00% or less, 16.00% or less, and 15.00% or less.

The mass ratio of the SiO₂ content to the total content of SiO₂ and B₂O₃ (SiO₂/(SiO₂+B₂O₃)) can be 0.300 or more, 0.320 or more, 0.340 or more, 0.360 or more, 0.380 or more, 0.400 or more from the viewpoint of the improvement of the thermal stability of glass. The mass ratio (SiO₂/(SiO₂+B₂O₃)) can be, for example, 0.900 or less, 0.850 or less, 0.800 or less, 0.750 or less, or 0.700 or less.

The La₂O₃ content is 20.00% or more, and can be 21.00% or more, 22.00% or more, 23.00% or more, 24.00% or more, 25.00% or more, 26.00% or more, 27.00% or more, 28.00% or more, and 29.00% or more from the viewpoints of keeping the thermal stability of glass and attaining the higher refractive index and lower dispersion thereof. On the other hand, from the viewpoints of keeping the devitrification resistance of glass and keeping of the liquidus temperature thereof, the La₂O₃ content is 60.00% or less, and can be 59.00% or less, 58.00% or less, 57.00% or less, 56.00% or less, 55.00% or less, 54.00% or less, 53.00% or less, 52.00% or less, 51.00% or less, 50.00% or less, 49.00% or less, 48.00% or less, 47.00% or less, 46.00% or less, 45.00% or less, 44.00% or less, 43.00% or less, 42.00% or less, 41.00% or less, 40.00% or less, and 39.00% or less.

From the viewpoint of keeping the thermal stability of glass, the total content of La₂O₃, Gd₂O₃ and Y₂O₃ (La₂O₃+Gd₂O₃+Y₂O₃) can be 60.00% or less, 59.00% or less, 58.00% or less, 57.00% or less, 56.00% or less, 55.00% or less, 54.00% or less, 53.00% or less, 52.00% or less, 51.00% or less, 50.00% or less, 49.00% or less, 48.00% or less, and 47.00% or less. On the other hand, from the viewpoints of keeping the thermal stability of glass and attaining the higher refractive index and the lower dispersion thereof, the total content (La₂O₃+Gd₂O₃+Y₂O₃) can be 20.00% or more, 22.00% or more, 24.00% or more, 26.00% or more, 28.00% or more, 30.00% or more, 32.00% or more, 34.00% or more, 36.00% or more, 38.00% or more, and 40.00% or more.

The mass ratio of the total content of Gd₂O₃, and Y₂O₃ to the La₂O₃ content ((Gd₂O₃+Y₂O₃)/La₂O₃) can be 0.000, 0.000 or more, or more than 0.000, and, from the viewpoint of the improvement of the thermal stability of glass, can be 0.000 or more, more than 0.000, 0.050 or more, 0.100 or more, and 0.150 or more. Further, the mass ratio ((Gd₂O₃+Y₂O₃)/La₂O₃) can be 10.000 or less, 9.000 or less, 8.000 or less, 7.000 or less, 6.000 or less, 5.00 or less, 4.00 or less, 3.00 or less, 2.00 or less, 1.00 or less, 0.800 or less, 0.700 or less, 0.600 or less, and 0.500 or less from the viewpoint of attaining the higher refractive index and lower dispersion.

The Gd₂O₃ content can be, for example, 0%, 0% or more, more than 0%, 0.50% or more, 1.00% or more, 2.00% or more, 3.00% or more or 4.00% or more. Further, the Gd₂O₃ content can be, for example, 20.00% or less, 18.00% or less, 16.00% or less, 14.00% or less, 12.00% or less, or 10.00% or less.

The Y₂O₃ content can be, for example, 0%, 0% or more, more than 0%, 0.50% or more, 1.00% or more or 2.00% or more. Further, the Y₂O₃ content can be, for example, 10.00% or less, 9.00% or less, 8.00% or less, 7.00% or less, 6.00% or less, or 5.00% or less.

The mass ratio of the total content of La₂O₃, Gd₂O₃ and Y₂O₃ to the total content of SiO₂ and B₂O₃ ((La₂O₃+Gd₂O₃+Y₂O₃)/(SiO₂+B₂O₃)) is 2.750 or more, and can be 2.800 or more, 2.850 or more, 2.900 or more, and 2.950 or more from the viewpoint of attaining the higher refractive index and lower dispersion. On the other hand, from the viewpoints of keeping the thermal stability of glass, keeping the devitrification resistance of glass, and keeping the liquidus temperature thereof, the mass ratio ((La₂O₃+Gd₂O₃+Y₂O₃)/(SiO₂+B₂O₃)) can be 5.000 or less, 4.750 or less, 4.500 or less, 4.250 or less, 4.000 or less, 3.750 or less, and 3.500 or less.

The Nb₂O₅ content is 8.80% or more, and can be 9.00% or more, 10.00% or more, 11.00% or more, 12.00% or more, and 13.00% or more from the viewpoints of attaining the higher refractive index and the improvement of the devitrification resistance of glass. On the other hand, from the viewpoints of keeping the devitrification resistance of glass and keeping the liquidus temperature thereof, the Nb₂O₅ content can be 25.00% or less, 24.00% or less, 23.00% or less, 22.00% or less, 21.00% or less, 20.00% or less, and 19.00% or less.

The TiO₂ content is 5.00% or more, and can be 6.00% or more, 7.00% or more, 8.00% or more, 9.00% or more, 10.00% or more, and 11.00% or more from the viewpoints of attaining a higher refractive index of glass and improving the devitrification resistance thereof. On the other hand, from the viewpoints of keeping the devitrification resistance of glass, keeping the liquidus temperature thereof, and keeping the transmittance thereof, the TiO₂ content is 20.00% or less, and can be 19.00% or less, 18.00% or less, 17.00% or less, and 16.00% or less.

The mass ratio of the total content of Nb₂O₅ and TiO₂ to the total content of SiO₂ and B₂O₃ ((Nb₂O₅+TiO₂)/(SiO₂+B₂O₃)) is 1.400 or more, and can be 1.500 or more, 1.600 or more, and 1.700 or more from the viewpoints of attaining the higher refractive index of glass and improving the devitrification resistance thereof. On the other hand, from the viewpoints of keeping the devitrification resistance of glass, keeping the liquidus temperature thereof, and keeping the transmittance thereof, the mass ratio ((Nb₂O₅+TiO₂)/(SiO₂+B₂O₃)) can be 3.000 or less, 2.900 or less, 2.800 or less, 2.700 or less, 2.600 or less, 2.500 or less, 2.400 or less, and 2.300 or less.

From the viewpoint of attaining a higher refractive index of glass, the mass ratio of the total content of Nb₂O₅ and TiO₂ to the SiO₂ content ((Nb₂O₅+TiO₂)/SiO₂) can be 2.400 or more, 2.500 or more, 2.600 or more, 2.700 or more, and 2.800 or more. On the other hand, from the viewpoint of keeping the thermal stability of glass, the mass ratio ((Nb₂O₅+TiO₂)/SiO₂) can be 10.00 or less, 9.00 or less, 8.00 or less, 7.00 or less, 6.000 or less, 5.500 or less, 5.000 or less, and 4.550 or less.

The mass ratio of the total content of Nb₂O₅, TiO₂, ZrO₂ and WO₃ to the total content of SiO₂ and B₂O₃ ((Nb₂O₅+TiO₂+ZrO₂+WO₃)/(SiO₂+B₂O₃)) is 1.600 or more, and can be 1.700 or more, 1.800 or more, 1.900 or more, 2.000 or more, and 2.100 or more from the viewpoints of attaining a higher refractive index of glass and improving the devitrification resistance thereof. On the other hand, from the viewpoints of keeping the thermal stability of glass, keeping the devitrification resistance of glass, keeping the liquidus temperature thereof, and keeping the transmittance thereof, the mass ratio ((Nb₂O₅+TiO₂+ZrO₂+WO₃)/(SiO₂+B₂O₃)) can be 4.000 or less, 3.800 or less, 3.600 or less, 3.400 or less, 3.200 or less, 3.000 or less, 2.900 or less, 2.800 or less, and 2.700 or less.

The total content of Nb₂O₅, TiO₂, ZrO₂ and WO₃ (Nb₂O₅+TiO₂+ZrO₂+WO₃) can be 29.50% or more, 30.00% or more, 30.50% or more from the viewpoint of attaining a higher refractive index of glass. On the other hand, from the viewpoints of keeping the thermal stability of glass, keeping the devitrification resistance of glass, and keeping the liquidus temperature thereof, the total content (Nb₂O₅+TiO₂+ZrO₂+WO₃) can be 40.00% or less, 39.00% or less, 38.00% or less, 37.00% or less, and 36.50% or less.

The ZrO₂ content can be 0%, 0% or more, more than 0%, 0.50% or more, 1.00% or more, 2.00% or more, 3.00% or more, 4.00% or more, or 5.00% or more from the viewpoints of attaining a higher refractive index and improving the devitrification resistance. On the other hand, the ZrO₂ content can be 10.00% or less, 9.00% or less, 8.00% or less from the viewpoint of suppressing the reduction of the devitrification resistance.

The WO₃ content can be 0%, 0% or more, more than 0%, 0.10% or more, 0.50% or more, 1.00% or more, 1.50% or more, or 2.00% or more from the viewpoints of attaining a higher refractive index and reducing the liquidus temperature. On the other hand, from the viewpoints of keeping the devitrification resistance and keeping the liquidus temperature, the WO₃ content can be 8.00% or less, 7.00% or less, 6.00% or less, and 5.00% or less.

The Ta₂O₅ content can be 0%, 0% or more, more than 0%, 0.10% or more, 0.50% or more, 1.00% or more, 1.50% or more, or 2.00% or more from the viewpoints of attaining a higher refractive index and keeping lower dispersion. On the other hand, from the viewpoints of keeping the devitrification resistance and reducing the cost of glass because of Ta₂O₅ being an expensive component, the Ta₂O₅ content can be 10.00% or less, 8.00% or less, 6.00% or less, 4.00 or less, and 2.00% or less.

The mass ratio of the total content of La₂O₃, Gd₂O₃ and Y₂O₃ to the total content of Nb₂O₅, TiO₂, ZrO₂ and WO₃ ((La₂O₃+Gd₂O₃+Y₂O₃)/(Nb₂O₅+TiO₂+ZrO₂+WO₃)) can be 0.740 or more, 0.800 or more, 0.900 or more, 1.000 or more, 1.100 or more, and 1.200 or more from the viewpoint of attaining lower dispersion. The mass ratio ((La₂O₃+Gd₂O₃+Y₂O₃)/(Nb₂O₅+TiO₂+ZrO₂+WO₃)) can be, for example, 3.000 or less, 2.600 or less, 2.200 or less, 2.000 or less, 1.800 or less, 1.700 or less, 1.600 or less, or 1.500 or less.

The total content of MgO, CaO, SrO, BaO, and ZnO (MgO+CaO+SrO+BaO+ZnO) can be 2.00% or more, and 3.00% or more, 4.00% or more, and 5.00% or more from the viewpoints of attaining lower dispersion of glass, improving the meltability of glass, improving the devitrification resistance of glass, and reducing the liquidus temperature thereof. On the other hand, from the viewpoint of keeping the higher refractive index of glass, the total content (MgO+CaO+SrO+BaO+ZnO) can be 22.00% or less, 20.00% or less, 18.00% or less, 16.00% or less, 14.00% or less, 12.00% or less, 10.00% or less, and 9.00% or less.

The MgO content can be 0%, 0% or more, more than 0%, 0.10% or more, 1.00% or more, or 2.00% or more from the viewpoints of improving the meltability of glass and reducing the glass transition temperature Tg thereof. On the other hand, from the viewpoint of keeping the high refractive index, the MgO content can be, for example, 10.00% or less, 9.00% or less, 8.00% or less, 7.00% or less, 6.00% or less, 5.00% or less, 4.00% or less, or 3.00% or less.

The CaO content can be 0%, 0% or more, more than 0%, 0.10% or more, 1.00% or more, or 2.00% or more from the viewpoints of improving the meltability of glass and reducing the glass transition temperature Tg thereof. On the other hand, from the viewpoint of keeping the high refractive index, the CaO content can be, for example, 10.00% or less, 9.00% or less, 8.00% or less, 7.00% or less, 6.00% or less, 5.00% or less, or 4.50% or less.

The SrO content can be 0%, 0% or more, more than 0%, 0.10% or more, 1.00% or more, or 2.00% or more from the viewpoints of improving the meltability of glass and reducing the glass transition temperature Tg thereof. On the other hand, from the viewpoint of keeping the high refractive index, the SrO content can be, for example, 10.00% or less, 9.00% or less, 8.00% or less, or 7.50% or less.

The BaO content can be 0%, 0% or more, more than 0%, 0.10% or more, or 0.50% or more from the viewpoints of improving the meltability of glass and reducing the glass transition temperature Tg thereof. Further, the BaO content can be, for example, 10.00% or less, 9.00% or less, 8.00% or less, 7.00% or less, 6.00% or less, or 5.50% or less.

The ZnO content can be 0%, 0% or more, more than 0%, 0.10% or more, or 0.50% or more from the viewpoints of attaining a higher refractive index, improving the meltability of glass and reducing the glass transition temperature Tg thereof. On the other hand, from the viewpoint of keeping the devitrification resistance, the ZnO content can be, for example, 10.00% or less, 9.00% or less, 8.00% or less, 7.00% or less, or 6.00% or less.

The mass ratio of the total content of MgO, CaO, SrO, BaO, and ZnO to the total content of SiO₂ and B₂O₃ ((MgO+CaO+SrO+BaO+ZnO)/(SiO₂+B₂O₃)) is, 0.300 or more, and can be 0.320 or more, 0.340 or more, and 0.360 or more from the viewpoints of improving the devitrification resistance of glass, attaining lower dispersion of glass, and improving the meltability of glass. On the other hand, from the viewpoint of keeping the high refractive index of glass, the mass ratio ((MgO+CaO+SrO+BaO+ZnO)/(SiO₂+B₂O₃)) can be 0.800 or less, 0.750 or less, 0.700 or less, and 0.650 or less.

The mass ratio of the total content of MgO, CaO, SrO, BaO, and ZnO to the total content of Nb₂O₅, TiO₂, ZrO₂, and WO₃ ((MgO+CaO+SrO+BaO+ZnO)/(Nb₂O₅+TiO₂+ZrO₂+WO₃)) is 0.290 or less, and can be 0.280 or less, 0.270 or less, 0.260 or less, and 0.250 or less from the viewpoint of keeping the high refractive index of glass. On the other hand, from the viewpoints of attaining lower dispersion of glass, and improving the meltability of glass, the mass ratio ((MgO+CaO+SrO+BaO+ZnO)/(Nb₂O₅+TiO₂+ZrO₂+WO₃)) can be 0.100 or more, 0.110 or more, 0.120 or more, 0.130 or more, 0.140 or more, and 0.150 or more.

The mass ratio of the total content of MgO, CaO, SrO, BaO, and ZnO to the total content of La₂O₃, Gd₂O₃, and Y₂O₃ ((MgO+CaO+SrO+BaO+ZnO)/(La₂O₃+Gd₂O₃+Y₂O₃)) can be 0.410 or less, 0.400 or less, 0.350 or less, 0.300 or less, 0.250 or less, and 0.200 or less from the viewpoint of keeping the high refractive index of glass. The mass ratio ((MgO+CaO+SrO+BaO+ZnO)/(La₂O₃+Gd₂O₃+Y₂O₃)) can be for example, more than 0.000, 0.010 or more, 0.050 or more, or 0.100 or more.

The total content of MgO, CaO, SrO, and BaO (MgO+CaO+SrO+BaO) can be 0%, 0% or more, more than 0%, 0.10% or more, 0.50% or more, or 1.00% or more from the viewpoints of improving the meltability of glass and reducing the glass transition temperature Tg thereof. From the viewpoints of attaining lower dispersion of glass, improving the meltability thereof, and reducing the liquidus temperature thereof, the total content (MgO+CaO+SrO+BaO) can be 20.00% or less, 18.00% or less, 16.00% or less, 14.00% or less, 12.00% or less, 10.00% or less, and 8.00% or less.

The mass ratio of the total content of MgO, CaO, SrO, and BaO to the total content of SiO₂ and B₂O₃ ((MgO+CaO+SrO+BaO)/(SiO₂+B₂O₃)) can be, for example, 0.000, and can also be 0.000 or more, more than 0.000, 0.010 or more, 0.030 or more, 0.050 or more, 0.070 or more, or 0.090 or more from the viewpoints of improving the meltability of glass, and attaining a higher refractive index thereof. From the viewpoints of keeping the thermal stability of glass, reducing the liquidus temperature thereof, and attaining lower dispersion thereof, the mass ratio ((MgO+CaO+SrO+BaO)/(SiO₂+B₂O₃)) can be 5.000 or less, 4.000 or less, 3.000 or less, 2.000 or less, 1.000 or less, 0.800 or less, and 0.600 or less.

The above optical glass can be a glass including one or more alkali metal oxides or can be a glass including no alkali metal oxide. When an alkali metal oxide is expressed as R₂O, the R₂O content (i.e., the total content of alkali metal oxides) can be 0%, 0% or more, more than 0%, 0.10% or more, 0.20% or more, or 0.30% or more from the viewpoints of improving the meltability of glass and reducing the glass transition temperature Tg thereof. From the viewpoints of keeping the thermal stability of glass and keeping the high refractive index thereof, the R₂O content can be 15.00% or less, and can be 13.00% or less, 11.00% or less, 9.00% or less, 8.00% or less, 7.00% or less, 6.00% or less, 5.00% or less, 4.00% or less, 3.00% or less, 2.00% or less, or 1.50% or less.

As the alkali metal oxide R₂O, mention may be made of one or more alkali metal oxides selected from the group consisting of Li₂O, Na₂O, K₂O, and Cs₂O. The optical glass can include only one alkali metal oxide selected from the group consisting of Li₂O, Na₂O, K₂O, and Cs₂O, and can include two, three, or four thereof.

The Li₂O content can be, for example, 0%, 0% or more, more than 0%, 0.10% or more, or 0.30% or more from the viewpoints of improving the meltability of glass and reducing the glass transition temperature Tg thereof. Further, from the viewpoints of keeping the thermal stability of glass, and keeping the high refractive index thereof, the Li₂O content can be, for example, 10.00% or less, 8.00% or less, 6.00% or less, 4.00% or less, 2.00% or less, 1.00% or less, or 0.80% or less.

The Na₂O content can be, for example, 0%, 0% or more, more than 0%, 0.10% or more, or 0.30% or more from the viewpoints of improving the meltability of glass and reducing the glass transition temperature Tg thereof. Further, from the viewpoints of keeping the thermal stability of glass, and keeping the high refractive index thereof, the Na₂O content can be, for example, 10.00% or less, 8.00% or less, 6.00% or less, 4.00% or less, 2.00% or less or 1.00% or less.

The K₂O content can be, for example, 0%, 0% or more, more than 0%, 0.10% or more, or 0.30% or more from the viewpoints of improving the meltability of glass and reducing the glass transition temperature Tg thereof. Further, from the viewpoints of keeping the thermal stability of glass and keeping the high refractive index thereof, the K₂O content can be, for example, 10.00% or less, 8.00% or less, 6.00% or less, 4.00% or less, 2.00% or less or 1.50% or less.

The Cs₂O content can be, for example, 0%, 0% or more, more than 0%, 0.10% or more, or 0.30% or more from the viewpoints of improving the meltability of glass and reducing the glass transition temperature Tg thereof. Further, from the viewpoints of keeping the thermal stability of glass and keeping the high refractive index thereof, the Cs₂O content can be, for example, 10.00% or less, 8.00% or less, 6.00% or less, 4.00% or less, 2.00% or less, 1.00% or less or 0.80% or less.

The above optical glass can also be a glass not including Al₂O₃, and can also be a glass including Al₂O₃ from the viewpoint of improving the thermal stability of glass. The Al₂O₃ content can be, for example, 0%, 0% or more, more than 0%, or 0.10% or more. Further, from the viewpoints of keeping the meltability and the devitrification resistance of glass, and keeping the liquidus temperature thereof, the Al₂O₃ content can be, for example, 5.00% or less, 4.00% or less, 3.00% or less, 2.00% or less, 1.00% or less, 0.80% or less, or 0.60% or less.

Sb₂O₃ is a component capable of being added as a clarifying agent. Addition thereof in a small amount can act as suppressing the reduction of the light transmittance due to mixing of impurities such as Fe. When the amount of Sb₂O₃ to be added is increased, coloring of glass exhibits an upward trend. Therefore, the amount of Sb₂O₃ to be added can be 0.00% or more and 0.10% or less, 0.00% or more and 0.05% or less, 0.00% or more and 0.03% or less in an external ratio. The term “the Sb₂O₃ content in an external ratio” means the content of Sb₂O₃ expressed in mass % when the total content of the glass components except for Sb₂O₃ is assumed to be 100 mass %.

SnO₂ can also be added as a clarifying agent. However, when SnO₂ is added in an amount of more than 1.00% in an external ratio, glass is colored, or the devitrification trend is caused with Sn as the starting point for nucleation for heating and softening glass for reforming such as press molding. Therefore, the amount of SnO₂ to be added can be set at 0.00% or more and 1.00% or less, 0.00% or more and 0.50% or less in an external ratio, and in one embodiment, SnO₂ is not added. The term “SnO₂ content in an external ratio” means the content of SnO₂ expressed in mass % when the total content of glass components except for SnO₂ is assumed to be 100 mass %.

The above optical glass can be manufactured without being allowed to include components such as Lu and Hf. Lu and Hf are each an expensive component. For this reason, each content of Lu₂O₃, and HfO₂ can be suppressed to 0.00% or more and 2.00% or less, to 0.00% or more and 1.00% or less, to 0.00% or more and 0.80% or less, and to 0.00% or more and 0.10% or less. In one embodiment, Lu₂O₃ is not introduced, and/or HfO₂ is not introduced.

Further, in one embodiment, Pb is not introduced in consideration of environmental impact, and/or one or more of, or all of, As, U, Th, Te, and Cd, are not introduced.

Further, in one embodiment, from the viewpoint of taking advantage of the excellent light transmittance of glass, one or more substances causing coloring such as Cu, Cr, V, Fe, Ni, and Co are not introduced.

F is a component for remarkably increasing the volatility of glass upon melting, and causing the reduction of the stability and the homogeneity of the optical characteristics of glass. The F content can be specified by the content (unit: mass %) in an external ratio of an F element relative to a total content of glass composition based on oxides of 100 mass % determined as described previously. In the above optical glass, the F content thus specified can be less than 0.10%, less than 0.08%, and less than 0.05%. The F content can be 0.00% or more, and can be 0.00%.

### <Glass Physical Properties>

### (Refractive Index nd)

The above optical glass can be a high refractive index glass from the viewpoint of the usability as a material for an optical element. From such a viewpoint, the refractive index nd of the above optical glass can be 1.95000 or more, 1.96000 or more, 1.97000 or more, 1.98000 or more, 1.98200 or more, 1.98400 or more, 1.98600 or more, 1.98800 or more, and 1.99000. The refractive index nd of the above optical glass can be, for example, 2.10000 or less or 2.05000 or less, and can exceed the values herein exemplified.

### (Abbe's Number vd)

The above optical glass can be a low dispersion glass from the viewpoint of the usability as a material for an optical element. From such a viewpoint, the Abbe's number vd of the above optical glass can be 20.00 or more, 22.00 or more, 24.00 or more, 24.50 or more, 25.00 or more, 25.50 or more, and 26.00 or more. Further, from the viewpoint of the usability as a material for an optical element, the Abbe's number vd of the above optical glass can be 35.00 or less, 33.00 or less, 31.00 or less, 30.00 or less, and 29.00 or less.

### (Specific Gravity)

The specific gravity of optical glass being low is preferable from the viewpoint of the weight reduction of the optical element. The specific gravity of the above optical glass can be, for example, 5.50 or less, 5.40 or less, 5.30 or less, and 5.20 or less. Further, the specific gravity of the above optical glass can be, for example, 4.50 or more. In one embodiment, a lower specific gravity is more preferable. For this reason, the lower limit thereof has no particular restriction. In the present disclosure and in the present specification, the term “specific gravity” is assumed to be the value measured by the Archimedes method.

### (Glass Transition Temperature Tg)

The above optical glass has the glass composition, and thereby can have a low glass transition temperature Tg. A low Tg glass is preferable, for example, from the viewpoint of suppressing the deterioration of a mold release film in press molding, the viewpoint of suppressing the waste of a mold for press molding, or other viewpoints. The Tg of the above optical glass can be 750° C. or less, 740° C. or less, 730° C. or less, 720° C. or less, 710° C. or less, and 700° C. or less. The lower limit of Tg has no particular restriction, and can be, for example, 500° C. or more, 550° C. or more, or 600° C. or more. The term “glass transition temperature Tg” in the present disclosure and the present specification is assumed to be the value to be measured at a heating rate of 10° C./min using a differential scanning calorimeter.

### (Devitrification Resistance)

As the index for the devitrification resistance, evaluation can be performed by the thickness of the surface devitrified layer which can be determined by the method described in the column of Example described later. For the devitrification resistance of the optical glass, the thickness of the surface devitrified layer can be 60 μm or less (rank A or rank B described later), and 40 μm or less (rank A described later).

### <Manufacturing Method of Optical Glass>

The above optical glass can be obtained in the following manner. In order to obtain an objective glass composition, an oxide, a carbonic acid salt, a sulfuric acid salt, a nitric acid salt, a hydroxide, and the like of raw materials were weighed, and compounded, and sufficiently mixed, resulting in a mixed batch, and heating, melting, defoaming, and stirring were performed in a melting vessel, thereby making molten glass not including foams, and the resulting glass is formed. Specifically, the above optical glass can be manufactured using a known melting method.

Glass material for press molding, optical element blank, and manufacturing method thereof

Another aspect of the present disclosure relates to:

a glass material for press molding comprised of the above optical glass; and

an optical element blank comprised of the above optical glass.

A still other aspect of the present disclosure also provides:

a method of manufacturing a glass material for press molding including a step of forming the above optical glass into a glass material for press molding;

a method of manufacturing an optical element blank including a step of press molding the above glass material for press molding using a mold for press molding; and

a method of manufacturing an optical element blank including a step of forming the above optical glass into an optical element blank.

The optical element blank is an optical element base material in a shape closely analogous to the shape of the objective optical element, and added with a polishing margin (the surface layer to be removed by polishing), if required, to the shape of the optical element. The surface of the optical element blank is ground and polished, thereby finishing an optical element. In one embodiment, an optical element blank can be manufactured by the method of press molding the molten glass obtained by melting a proper amount of the glass (which is referred to as a direct press method). In another embodiment, an optical element blank can be manufactured by vitrifying the molten glass obtained by melting a proper amount of the glass.

Further, in a still other embodiment, an optical element blank can be manufactured by manufacturing a glass material for press molding, and press molding the manufactured glass material for press molding.

The press molding of the glass material for press molding can be performed by a known method in which a glass material for press molding which has been heated and softened is pressed by a mold for press molding. Heating and press molding both can be performed in the atmosphere. By performing annealing after press molding, and reducing the strain inside glass, it is possible to obtain a homogeneous optical element blank.

The glass materials for press molding also include, in addition to the one referred to as a glass gob for press molding to be subjected as it is to press molding for manufacturing an optical element blank, the one to be subjected to machining such as cutting, grinding, or polishing, and to go through a glass gob for press molding for being subjected to press molding. The cutting methods include a method in which a groove is formed in the portion to be cut of the surface of the glass sheet by a process called scribing, and the portion of the groove is applied with a local force from the back surface of the surface including the groove formed therein, thereby breaking the glass sheet at the portion of the groove, a method for cutting a glass sheet by a cutting blade, and other methods. Further, as grinding and polishing methods, mention may be made of barrel polishing, and the like.

The glass material for press molding can be manufactured in the following manner. For example, molten glass is casted into a mold, and formed into a casting glass sheet, the glass sheet is cut into a plurality of glass pieces. Alternatively, a glass gob for press molding can also be manufactured by forming a proper amount of molten glass. An optical element blank can also be manufactured by reheating and softening, and press molding glass gob for press molding. The method in which glass is reheated and softened for press molding, thereby manufacturing an optical element blank is referred to as a reheat press method in contrast to the direct press method.

### [Optical Element and Manufacturing Method Thereof]

Another aspect of the present disclosure relates to,

an optical element comprised of the above optical glass.

The above optical element is manufactured using the above optical glass. In the above optical element, on the glass surface, one- or more-layer coating of, for example, a multilayer film of an antireflection film, or the like can be formed.

Further, a still other aspect of the present disclosure also provides,

a method of manufacturing an optical element, including a step of grinding and/or polishing the above optical element blank, and thereby manufacturing an optical element.

In the above method of manufacturing an optical element, machining such as grinding, polishing and the like can be performed by applying a known method thereto. After machining, the surface of the optical element is sufficiently washed, and dried, and is subjected to other procedures. As a result, an optical element with high inside quality and surface quality can be obtained. In this manner, an optical element comprised of the above optical glass can be obtained. Examples of the optical element can include various lenses such as a spherical lens, an aspherical lens, and a microlens, and prisms.

Further, the optical element comprised of the above optical glass is also preferable as a lens configuring a junction optical element. Examples of the junction optical element can include the one obtained by joining lenses (junction lens), and the one obtained by joining a lens and a prism. For example, the junction optical element can be manufactured in the following manner; the junction surfaces of the two optical elements to be joined are subjected to precision machining (for example, spherical polishing processing) so that the shapes can become inverted shapes, and are applied with an ultraviolet ray curable adhesive for use in bonding of junction lenses, and are bonded to each other; and then irradiated with an ultraviolet ray through the lenses for curing the adhesive. In order to manufacture a junction optical element in this manner, the above optical glass is preferable. A plurality of optical elements to be joined are manufactured using a plurality of glasses having different Abbe's numbers vd, respectively, and are joined. As a result, it is possible to implement preferable elements for correcting the chromatic aberration.

### EXAMPLES

Below, the present disclosure will be described in more details by way of Examples. However, the present disclosure is not limited to the embodiments shown in Examples.

### Example 1, Comparative Example 1

### <Manufacturing of Optical Glass.

Using a nitric acid salt, a sulfuric acid salt, a carbonic acid salt, a hydroxide, an oxide, boric acid, and the like respectively corresponding to the raw materials for introducing each component so as to achieve the glass compositions shown in Tables below, the raw materials were weighed and sufficiently mixed, resulting in a compounded raw material.

The compounded raw material was placed in a crucible made of platinum, was heated in a furnace set at 1200° C. to 1400° C., and was molten for two hours. After stirring and homogenizing the molten glass, the molten glass was poured into a preheated mold, and was allowed to stand to around the glass transition temperature, immediately followed by being placed into an annealing furnace. Thus, the glass was held at a temperature of approximately the glass transition temperature for about 30 minutes, and then was gradually cooled at a gradual cooling rate of −30° C./hour for 4 hours. Subsequently, the glass was allowed to stand to room temperature in the furnace, resulting in each optical glass of Example 1 (Nos. 1 to 66) and Comparative Example 1 shown in Tables below.

### <Evaluation of Physical Properties of Optical Glass>

The various physical properties of the optical glasses obtained above are shown in Tables below.

The various physical properties of the optical glasses were measured by the methods shown below.

### (1) Refractive Index nd Abbe's Number vd

The refractive index nd and the Abbe's number vd were measured by the refractive index measuring method of Japan Optical Glass Manufacturers' Association Standard.

### (2) Glass Transition Temperature Tg

The glass transition temperature Tg was measured at a heating rate of 10° C./min using the differential scanning calorimeter (DSC3300SA) manufactured by NETZSCH JAPAN Co.

### (3) Specific Gravity

The specific gravity was measured by the Archimedes method.

### (4) Devitrification Resistance (Rating According to Thickness of Surface Devitrified Layer)

The optical glass obtained above was cut into dimensions of 1 cm×1 cm×1 cm, thereby manufacturing a glass sample. The manufactured glass sample was heated in a first test furnace with the furnace temperature set at the glass transition temperature Tg for 10 minutes, and further heated in a second test furnace with the furnace temperature set at a higher temperature than the glass transition temperature Tg by 180° C. to 200° C. for 10 minutes. The surfaces (two parallel surfaces) of the glass sample after heating was optically polished. The glass sample after optical polishing was visually observed by means of an optical microscope (observation magnification: 10 to 100 times), and the thickness of the devitrified (crystalline) portion of the surface layer was measured. The thickness thus measured is assumed to be the “thickness of the surface devitrified layer”. The thickness of the surface devitrified layer of 40 μm or less was rated as rank A, the thickness of more than 40 μm and 60 μm or less was rated as rank B, and the thickness of more than 60 3 μm was rated as rank C.

As shown in Tables below, each optical glass of Example 1 was superior in devitrification resistance to the optical glass of Comparative Example 1 with a Nb₂O₅ content of less than 8.80 mass %, a total content (MgO+CaO+SrO+BaO+ZnO) of less than 2.00%, and a mass ratio (MgO+CaO+SrO+BaO+ZnO)/(SiO₂+B₂O₃) of less than 0.300. The optical glass of Comparative Example 1 has the same glass composition as that of Example 29 of Japanese Patent Application Publication No. 2015-91752.

TABLE 1

| Sample No. (mass %) | 1 | 2 | 3 | 4 | 5 |
|---|---|---|---|---|---|
| Al₂O₃ | 0.00 | 0.00 | 0.00 | 0.00 | 0.00 |
| SiO₂ | 9.06 | 8.00 | 8.26 | 8.68 | 8.85 |
| B₂O₃ | 5.49 | 5.73 | 5.67 | 5.57 | 5.30 |
| Li₂O | 0.50 | 0.39 | 0.42 | 0.46 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 4.42 | 3.44 | 3.68 | 4.08 | 3.67 |
| SrO | 0.51 | 0.39 | 0.41 | 0.52 | 0.41 |
| BaO | 1.01 | 0.78 | 0.83 | 0.92 | 0.83 |
| ZnO | 0.53 | 0.57 | 0.56 | 0.54 | 0.56 |
| La₂O₃ | 35.26 | 37.47 | 36.95 | 36.02 | 36.86 |
| Gd₂O₃ | 7.54 | 8.27 | 8.08 | 7.79 | 8.06 |
| Y₂O₃ | 0.37 | 0.40 | 0.39 | 0.39 | 0.39 |
| ZrO₂ | 5.55 | 5.87 | 5.78 | 5.66 | 5.77 |
| Nb₂O₅ | 14.48 | 13.34 | 13.62 | 14.07 | 13.58 |
| TiO₂ | 15.29 | 15.34 | 15.33 | 15.30 | 15.29 |
| WO₃ | 0.00 | 0.00 | 0.00 | 0.00 | 0.00 |
| Total | 100 | 100 | 100 | 100 | 100 |
| Sb₂O₃ | 0.005 | 0.005 | 0.005 | 0.005 | 0.005 |
| R₂O | 0.500 | 0.390 | 0.420 | 0.463 | 0.419 |
| MgO + CaO + SrO + BaO | 5.940 | 4.618 | 4.929 | 5.516 | 4.916 |
| MgO + CaO + SrO + BaO + ZnO | 6.468 | 5.191 | 5.489 | 6.056 | 5.475 |
| SiO₂ + B₂O₃ | 14.55 | 13.73 | 13.93 | 14.25 | 14.16 |
| SiO₂/(SiO₂ + B₂O₃) | 0.623 | 0.583 | 0.593 | 0.609 | 0.625 |
| (MgO + CaO + SrO + BaO)/(SiO₂ + B₂O₃) | 0.408 | 0.336 | 0.354 | 0.387 | 0.347 |
| (MgO + CaO + SrO + BaO + ZnO)/(SiO₂ + B₂O₃) | 0.445 | 0.378 | 0.394 | 0.425 | 0.387 |
| Nb₂O₅ + TiO₂ + ZrO₂ + WO₃ | 35.32 | 34.56 | 34.73 | 35.03 | 34.64 |
| (Nb₂O₅ + TiO₂ + ZrO₂ + WO₃)/(SiO₂ + B₂O₃) | 2.428 | 2.518 | 2.493 | 2.457 | 2.447 |
| La₂O₃ + Gd₂O₃ + Y₂O₃ | 43.16 | 46.14 | 45.42 | 44.20 | 45.31 |
| (La₂O₃ + Gd₂O₃ + Y₂O₃)/(SiO₂ + B₂O₃) | 2.967 | 3.361 | 3.260 | 3.101 | 3.200 |
| (Gd₂O₃ + Y₂O₃)/La₂O₃ | 0.224 | 0.231 | 0.229 | 0.227 | 0.229 |
| (MgO + CaO + SrO + BaO + ZnO)/(La₂O₃ + Gd₂O₃ + Y₂O₃) | 0.150 | 0.113 | 0.121 | 0.137 | 0.121 |
| (MgO + CaO + SrO + BaO + ZnO)/(Nb₂O₅ + TiO₂ + ZrO₂ + WO₃) | 0.183 | 0.150 | 0.158 | 0.173 | 0.158 |
| (La₂O₃ + Gd₂O₃ + Y₂O₃)/(Nb₂O₅ + TiO₂ + ZrO₂ + WO₃) | 1.222 | 1.335 | 1.308 | 1.262 | 1.308 |
| (Nb₂O₅ + TiO₂)/SiO₂ | 3.287 | 3.585 | 3.505 | 3.382 | 3.261 |
| (Nb₂O₅ + TiO₂)/(SiO₂ + B₂O₃) | 2.047 | 2.090 | 2.078 | 2.061 | 2.040 |
| Specific gravity | 4.74 | 4.85 | 4.82 | 4.77 | 4.82 |
| Refractive index (nd) | 1.9982 | 2.00836 | 2.00565 | 2.00112 | 2.00303 |
| Abbe's number (νd) | 26.97 | 26.95 | 26.96 | 26.96 | 27.04 |
| Glass transition temperature Tg (° C.) | 690 | 719 | 695 | 709 | 700 |
| Surface devitrified layer(rank) | A | A | A | A | A |

TABLE 2

| Sample No. (mass %) | 6 | 7 | 8 | 9 | 10 |
|---|---|---|---|---|---|
| Al₂O₃ | 0.00 | 0.00 | 0.00 | 0.00 | 0.00 |
| SiO₂ | 9.45 | 10.03 | 7.06 | 6.46 | 8.77 |
| B₂O₃ | 4.93 | 4.56 | 6.42 | 6.80 | 5.25 |
| Li₂O | 0.42 | 0.42 | 0.42 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 3.66 | 3.65 | 3.70 | 3.71 | 3.07 |
| SrO | 0.41 | 0.41 | 0.42 | 0.42 | 0.41 |
| BaO | 0.83 | 0.83 | 0.84 | 0.84 | 2.38 |
| ZnO | 0.56 | 0.56 | 0.56 | 0.56 | 0.55 |
| La₂O₃ | 36.76 | 36.67 | 37.14 | 37.24 | 36.49 |
| Gd₂O₃ | 8.04 | 8.02 | 8.12 | 8.14 | 7.98 |
| Y₂O₃ | 0.39 | 0.39 | 0.40 | 0.40 | 0.39 |
| ZrO₂ | 5.75 | 5.74 | 5.81 | 5.83 | 5.71 |
| Nb₂O₅ | 13.55 | 13.51 | 13.69 | 13.73 | 13.45 |
| TiO₂ | 15.25 | 15.21 | 15.41 | 15.45 | 15.14 |
| WO₃ | 0.00 | 0.00 | 0.00 | 0.00 | 0.00 |
| Total | 100 | 100 | 100 | 100 | 100 |
| Sb₂O₃ | 0.005 | 0.005 | 0.005 | 0.005 | 0.005 |
| R₂O | 0.418 | 0.417 | 0.423 | 0.424 | 0.415 |
| MgO + CaO + SrO + BaO | 4.904 | 4.891 | 4.955 | 4.968 | 5.854 |
| MgO + CaO + SrO + BaO + ZnO | 5.461 | 5.447 | 5.518 | 5.532 | 6.407 |
| SiO₂ + B₂O₃ | 14.38 | 14.60 | 13.48 | 13.26 | 14.02 |
| SiO₂/(SiO₂ + B₂O₃) | 0.657 | 0.687 | 0.524 | 0.487 | 0.625 |
| (MgO + CaO + SrO + BaO)/(SiO₂ + B₂O₃) | 0.341 | 0.335 | 0.367 | 0.375 | 0.418 |
| (MgO + CaO + SrO + BaO + ZnO)/(SiO₂ + B₂O₃) | 0.380 | 0.373 | 0.409 | 0.417 | 0.457 |
| Nb₂O₅ + TiO₂ + ZrO₂ + WO₃ | 34.55 | 34.46 | 34.91 | 35.01 | 34.30 |
| (Nb₂O₅ + TiO₂ + ZrO₂ + WO₃)/(SiO₂ + B₂O₃) | 2.403 | 2.361 | 2.589 | 2.640 | 2.447 |
| La₂O₃ + Gd₂O₃ + Y₂O₃ | 45.19 | 45.07 | 45.66 | 45.78 | 44.86 |
| (La₂O₃ + Gd₂O₃ + Y₂O₃)/(SiO₂ + B₂O₃) | 3.143 | 3.088 | 3.386 | 3.453 | 3.200 |
| (Gd₂O₃ + Y₂O₃)/La₂O₃ | 0.229 | 0.229 | 0.229 | 0.229 | 0.229 |
| (MgO + CaO + SrO + BaO + ZnO)/(La₂O₃ + Gd₂O₃ + Y₂O₃) | 0.121 | 0.121 | 0.121 | 0.121 | 0.143 |
| (MgO + CaO + SrO + BaO + ZnO)/(Nb₂O₅ + TiO₂ + ZrO₂ + WO₃) | 0.158 | 0.158 | 0.158 | 0.158 | 0.187 |
| (La₂O₃ + Gd₂O₃ + Y₂O₃)/(Nb₂O₅ + TiO₂ + ZrO₂ + WO₃) | 1.308 | 1.308 | 1.308 | 1.308 | 1.308 |
| (Nb₂O₅ + TiO₂)/SiO₂ | 3.049 | 2.863 | 4.120 | 4.516 | 3.261 |
| (Nb₂O₅ + TiO₂)/(SiO₂ + B₂O₃) | 2.003 | 1.968 | 2.158 | 2.201 | 2.040 |
| Specific gravity | 4.81 | 4.82 | 4.84 | 4.84 | 4.84 |
| Refractive index (nd) | 2.00096 | 1.99866 | 2.00911 | 2.01109 | 2.00252 |
| Abbe's number (νd) | 27.06 | 27.11 | 26.89 | 26.84 | 27.05 |
| Glass transition temperature Tg (° C.) | 707 | 698 | 692 | 690 | 694 |
| Surface devitrified layer(rank) | A | A | A | A | A |

TABLE 3

| Sample No. (mass %) | 11 | 12 | 13 | 14 | 15 |
|---|---|---|---|---|---|
| Al₂O₃ | 0.00 | 0.00 | 0.00 | 0.00 | 0.00 |
| SiO₂ | 8.68 | 8.60 | 8.84 | 8.82 | 8.78 |
| B₂O₃ | 5.20 | 5.15 | 5.29 | 5.28 | 5.26 |
| Li₂O | 0.41 | 0.41 | 0.42 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 2.47 | 1.89 | 3.66 | 2.74 | 1.82 |
| SrO | 0.41 | 0.40 | 0.00 | 0.41 | 0.41 |
| BaO | 3.90 | 5.38 | 1.44 | 0.83 | 0.83 |
| ZnO | 0.55 | 0.54 | 0.56 | 1.88 | 3.20 |
| La₂O₃ | 36.14 | 35.79 | 36.78 | 36.70 | 36.55 |
| Gd₂O₃ | 7.90 | 7.82 | 8.04 | 8.02 | 7.99 |
| Y₂O₃ | 0.39 | 0.38 | 0.39 | 0.39 | 0.39 |
| ZrO₂ | 5.65 | 5.60 | 5.76 | 5.74 | 5.72 |
| Nb₂O₅ | 13.32 | 13.19 | 13.56 | 13.53 | 13.47 |
| TiO₂ | 14.99 | 14.85 | 15.26 | 15.23 | 15.17 |
| WO₃ | 0.00 | 0.00 | 0.00 | 0.00 | 0.00 |
| Total | 100 | 100 | 100 | 100 | 100 |
| Sb₂O₃ | 0.005 | 0.005 | 0.005 | 0.005 | 0.005 |
| R₂O | 0.411 | 0.407 | 0.418 | 0.418 | 0.416 |
| MgO + CaO + SrO + BaO | 6.773 | 7.675 | 5.105 | 3.981 | 3.053 |
| MgO + CaO + SrO + BaO + ZnO | 7.321 | 8.217 | 5.662 | 5.865 | 6.253 |
| SiO₂ + B₂O₃ | 13.88 | 13.75 | 14.13 | 14.10 | 14.04 |
| SiO₂/(SiO₂ + B₂O₃) | 0.625 | 0.625 | 0.625 | 0.625 | 0.625 |
| (MgO + CaO + SrO + BaO)/(SiO₂ + B₂O₃) | 0.488 | 0.558 | 0.361 | 0.282 | 0.217 |
| (MgO + CaO + SrO + BaO + ZnO)/(SiO₂ + B₂O₃) | 0.527 | 0.598 | 0.401 | 0.416 | 0.445 |
| Nb₂O₅ + TiO₂ + ZrO₂ + WO₃ | 33.97 | 33.64 | 34.57 | 34.50 | 34.36 |
| (Nb₂O₅ + TiO₂ + ZrO₂ + WO₃)/(SiO₂ + B₂O₃) | 2.447 | 2.447 | 2.447 | 2.447 | 2.447 |
| La₂O₃ + Gd₂O₃ + Y₂O₃ | 44.42 | 43.99 | 45.22 | 45.12 | 44.93 |
| (La₂O₃ + Gd₂O₃ + Y₂O₃)/(SiO₂ + B₂O₃) | 3.200 | 3.200 | 3.200 | 3.200 | 3.200 |
| (Gd₂O₃ + Y₂O₃)/La₂O₃ | 0.229 | 0.229 | 0.229 | 0.229 | 0.229 |
| (MgO + CaO + SrO + BaO + ZnO)/(La₂O₃ + Gd₂O₃ + Y₂O₃) | 0.165 | 0.187 | 0.125 | 0.130 | 0.139 |
| (MgO + CaO + SrO + BaO + ZnO)/(Nb₂O₅ + TiO₂ + ZrO₂ + WO₃) | 0.216 | 0.244 | 0.164 | 0.170 | 0.182 |
| (La₂O₃ + Gd₂O₃ + Y₂O₃)/(Nb₂O₅ + TiO₂ + ZrO₂ + WO₃) | 1.308 | 1.308 | 1.308 | 1.308 | 1.308 |
| (Nb₂O₅ + TiO₂)/SiO₂ | 3.261 | 3.261 | 3.261 | 3.261 | 3.261 |
| (Nb₂O₅ + TiO₂)/(SiO₂ + B₂O₃) | 2.040 | 2.040 | 2.040 | 2.040 | 2.040 |
| Specific gravity | 4.86 | 4.89 | 4.81 | 4.85 | 4.88 |
| Refractive index (nd) | 2.00128 | 2.00024 | 2.0033 | 2.00648 | 2.01012 |
| Abbe's number (νd) | 27.08 | 27.08 | 27.01 | 26.88 | 26.77 |
| Glass transition temperature Tg (° C.) | 695 | 697 | 697 | 687 | 687 |
| Surface devitrified layer(rank) | A | A | A | A | A |

TABLE 4

| Sample No. (mass %) | 16 | 17 | 18 | 19 | 20 |
|---|---|---|---|---|---|
| Al₂O₃ | 0.00 | 0.00 | 0.00 | 0.00 | 0.00 |
| SiO₂ | 8.75 | 8.7 | 8.79 | 8.72 | 8.65 |
| B₂O₃ | 5.24 | 5.22 | 5.26 | 5.22 | 5.18 |
| Li₂O | 0.41 | 0.41 | 0.42 | 0.41 | 0.41 |
| Na₂O | 0.00 | 0.00 | 0.00 | 0.00 | 0.00 |
| K₂O | 0.00 | 0.00 | 0.00 | 0.00 | 0.00 |
| CaO | 0.90 | 0.00 | 2.73 | 1.80 | 0.89 |
| SrO | 0.41 | 0.41 | 2.10 | 3.75 | 5.38 |
| BaO | 0.82 | 0.82 | 0.83 | 0.82 | 0.81 |
| ZnO | 4.50 | 5.79 | 0.55 | 0.55 | 0.55 |
| La₂O₃ | 36.40 | 36.26 | 36.57 | 36.29 | 36.01 |
| Gd₂O₃ | 7.96 | 7.93 | 7.99 | 7.93 | 7.87 |
| Y₂O₃ | 0.39 | 0.39 | 0.39 | 0.39 | 0.38 |
| ZrO₂ | 5.70 | 5.6 | 5.72 | 5.68 | 5.64 |
| Nb₂O₅ | 13.42 | 13.36 | 13.48 | 13.38 | 13.27 |
| TiO₂ | 15.10 | 15.04 | 15.17 | 15.06 | 14.94 |
| WO₃ | 0.00 | 0.00 | 0.00 | 0.00 | 0.00 |
| Total | 100 | 100 | 100 | 100 | 100 |
| Sb₂O₃ | 0.005 | 0.005 | 0.005 | 0.005 | 0.005 |
| R₂O | 0.414 | 0.412 | 0.416 | 0.413 | 0.410 |
| MgO + CaO + SrO + BaO | 2.133 | 1.226 | 5.651 | 6.375 | 7.088 |
| MgO + CaO + SrO + BaO + ZnO | 6.637 | 7.015 | 6.206 | 6.925 | 7.633 |
| SiO₂ + B₂O₃ | 13.98 | 13.93 | 14.05 | 13.94 | 13.83 |
| SiO₂/(SiO₂ + B₂O₃) | 0.625 | 0.625 | 0.625 | 0.625 | 0.625 |
| (MgO + CaO + SrO + BaO)/(SiO₂ + B₂O₃) | 0.153 | 0.088 | 0.402 | 0.457 | 0.512 |
| (MgO + CaO + SrO + BaO + ZnO)/(SiO₂ + B₂O₃) | 0.475 | 0.504 | 0.442 | 0.497 | 0.552 |
| Nb₂O₅ + TiO₂ + ZrO₂ + WO₃ | 34.22 | 34.08 | 34.38 | 34.11 | 33.85 |
| (Nb₂O₅ + TiO₂ + ZrO₂ + WO₃)/(SiO₂ + B₂O₃) | 2.447 | 2.447 | 2.447 | 2.447 | 2.447 |
| La₂O₃ + Gd₂O₃ + Y₂O₃ | 44.75 | 44.57 | 44.96 | 44.61 | 44.27 |
| (La₂O₃ + Gd₂O₃ + Y₂O₃)/(SiO₂ + B₂O₃) | 3.200 | 3.200 | 3.200 | 3.200 | 3.200 |
| (Gd₂O₃ + Y₂O₃)/La₂O₃ | 0.229 | 0.229 | 0.229 | 0.229 | 0.229 |
| (MgO + CaO + SrO + BaO + ZnO)/(La₂O₃ + Gd₂O₃ + Y₂O₃) | 0.148 | 0.157 | 0.138 | 0.155 | 0.172 |
| (MgO + CaO + SrO + BaO + ZnO)/(Nb₂O₅ + TiO₂ + ZrO₂ + WO₃) | 0.194 | 0.206 | 0.181 | 0.203 | 0.225 |
| (La₂O₃ + Gd₂O₃ + Y₂O₃)/(Nb₂O₅ + TiO₂ + ZrO₂ + WO₃) | 1.308 | 1.308 | 1.308 | 1.308 | 1.308 |
| (Nb₂O₅ + TiO₂)/SiO₂ | 3.261 | 3.261 | 3.261 | 3.261 | 3.261 |
| (Nb₂O₅ + TiO₂)/(SiO₂ + B₂O₃) | 2.040 | 2.040 | 2.040 | 2.040 | 2.040 |
| Specific gravity | 4.92 | 4.95 | 4.84 | 4.86 | 4.88 |
| Refractive index (nd) | 2.01329 | 2.01631 | 2.0008 | 1.99857 | 1.99623 |
| Abbe's number (νd) | 26.65 | 26.45 | 27.06 | 27.22 | 27.25 |
| Glass transition temperature Tg (° C.) | 681 | 676 | 702 | 703 | 703 |
| Surface devitrified layer(rank) | A | A | A | A | A |

TABLE 5

| Sample No. (mass %) | 21 | 22 | 23 | 24 | 25 |
|---|---|---|---|---|---|
| Al₂O₃ | 0.00 | 0.00 | 0.00 | 0.00 | 0.00 |
| SiO₂ | 8.76 | 8.59 | 8.84 | 8.81 | 8.83 |
| B₂O₃ | 5.25 | 5.14 | 5.29 | 5.28 | 5.28 |
| Li₂O | 0.41 | 0.41 | 0.27 | 0.00 | 0.27 |
| Na₂O | 0.00 | 0.00 | 0.32 | 0.87 | 0.00 |
| K₂O | 0.00 | 0.00 | 0.00 | 0.00 | 0.48 |
| CaO | 0.00 | 0.00 | 3.66 | 3.65 | 3.66 |
| SrO | 7.12 | 6.98 | 0.41 | 0.41 | 0.41 |
| BaO | 0.82 | 0.81 | 0.83 | 0.83 | 0.83 |
| ZnO | 0.55 | 0.54 | 0.56 | 0.56 | 0.56 |
| La₂O₃ | 29.87 | 35.74 | 36.80 | 36.69 | 36.74 |
| Gd₂O₃ | 7.97 | 7.81 | 8.04 | 8.02 | 8.03 |
| Y₂O₃ | 4.97 | 0.38 | 0.39 | 0.39 | 0.39 |
| ZrO₂ | 5.71 | 5.59 | 5.76 | 5.74 | 5.75 |
| Nb₂O₅ | 13.44 | 13.18 | 13.56 | 13.52 | 13.54 |
| TiO₂ | 15.13 | 14.83 | 15.27 | 15.22 | 15.24 |
| WO₃ | 0.00 | 0.00 | 0.00 | 0.00 | 0.00 |
| Total | 100 | 100 | 100 | 100 | 100 |
| Sb₂O₃ | 0.005 | 0.005 | 0.005 | 0.005 | 0.005 |
| R₂O | 0.415 | 0.407 | 0.583 | 0.866 | 0.746 |
| MgO + CaO + SrO + BaO | 7.943 | 7.785 | 4.908 | 4.894 | 4.900 |
| MgO + CaO + SrO + BaO + ZnO | 8.496 | 8.327 | 5.466 | 5.450 | 5.457 |
| SiO₂ + B₂O₃ | 14.01 | 13.73 | 14.13 | 14.09 | 14.11 |
| SiO₂/(SiO₂ + B₂O₃) | 0.625 | 0.625 | 0.625 | 0.625 | 0.625 |
| (MgO + CaO + SrO + BaO)/(SiO₂ + B₂O₃) | 0.567 | 0.567 | 0.347 | 0.347 | 0.347 |
| (MgO + CaO + SrO + BaO + ZnO)/(SiO₂ + B₂O₃) | 0.607 | 0.607 | 0.387 | 0.387 | 0.387 |
| Nb₂O₅ + TiO₂ + ZrO₂ + WO₃ | 34.28 | 33.60 | 34.59 | 34.49 | 34.53 |
| (Nb₂O₅ + TiO₂ + ZrO₂ + WO₃)/(SiO₂ + B₂O₃) | 2.447 | 2.447 | 2.447 | 2.447 | 2.447 |
| La₂O₃ + Gd₂O₃ + Y₂O₃ | 42.80 | 43.94 | 45.23 | 45.10 | 45.16 |
| (La₂O₃ + Gd₂O₃ + Y₂O₃)/(SiO₂ + B₂O₃) | 3.056 | 3.200 | 3.200 | 3.200 | 3.200 |
| (Gd₂O₃ + Y₂O₃)/La₂O₃ | 0.433 | 0.229 | 0.229 | 0.229 | 0.229 |
| (MgO + CaO + SrO + BaO + ZnO)/(La₂O₃ + Gd₂O₃ + Y₂O₃) | 0.198 | 0.190 | 0.121 | 0.121 | 0.121 |
| (MgO + CaO + SrO + BaO + ZnO)/(Nb₂O₅ + TiO₂ + ZrO₂ + WO₃) | 0.248 | 0.248 | 0.158 | 0.158 | 0.158 |
| (La₂O₃ + Gd₂O₃ + Y₂O₃)/(Nb₂O₅ + TiO₂ + ZrO₂ + WO₃) | 1.249 | 1.308 | 1.308 | 1.308 | 1.308 |
| (Nb₂O₅ + TiO₂)/SiO₂ | 3.261 | 3.261 | 3.261 | 3.261 | 3.261 |
| (Nb₂O₅ + TiO₂)/(SiO₂ + B₂O₃) | 2.040 | 2.040 | 2.040 | 2.040 | 2.040 |
| Specific gravity | 4.83 | 4.90 | 4.81 | 4.80 | 4.81 |
| Refractive index (nd) | 1.99065 | 1.99382 | 2.00133 | 1.99705 | 2.00156 |
| Abbe's number (νd) | 27.31 | 27.38 | 27.06 | 26.98 | 27.02 |
| Glass transition temperature Tg (° C.) | 703 | 703 | 701 | 716 | 710 |
| Surface devitrified layer(rank) | A | A | A | A | A |

TABLE 6

| Sample No. (mass %) | 26 | 27 | 28 | 29 | 30 |
|---|---|---|---|---|---|
| Al₂O₃ | 0.00 | 0.00 | 0.00 | 0.00 | 0.00 |
| SiO₂ | 8.78 | 8.78 | 8.68 | 8.84 | 8.83 |
| B₂O₃ | 5.25 | 5.25 | 5.20 | 5.29 | 5.29 |
| Li₂O | 0.00 | 0.42 | 0.41 | 0.42 | 0.42 |
| Na₂O | 0.00 | 0.00 | 0.00 | 0.00 | 0.00 |
| K₂O | 1.31 | 0.00 | 0.00 | 0.00 | 0.00 |
| CaO | 3.64 | 3.64 | 3.60 | 3.66 | 3.66 |
| SrO | 0.41 | 0.41 | 0.41 | 0.41 | 0.41 |
| BaO | 0.82 | 0.82 | 0.82 | 0.83 | 0.83 |
| ZnO | 0.55 | 0.55 | 0.55 | 0.56 | 0.56 |
| La₂O₃ | 36.53 | 36.35 | 35.96 | 37.36 | 36.77 |
| Gd₂O₃ | 7.98 | 7.98 | 7.90 | 8.04 | 8.67 |
| Y₂O₃ | 0.39 | 0.39 | 0.39 | 0.00 | 0.00 |
| ZrO₂ | 5.72 | 5.72 | 5.66 | 5.76 | 5.75 |
| Nb₂O₅ | 13.46 | 16.16 | 18.65 | 13.56 | 13.55 |
| TiO₂ | 15.15 | 13.53 | 11.79 | 15.26 | 15.25 |
| WO₃ | 0.00 | 0.00 | 0.00 | 0.00 | 0.00 |
| Total | 100 | 100 | 100 | 100 | 100 |
| Sb₂O₃ | 0.005 | 0 | 0 | 0 | 0 |
| R₂O | 1.310 | 0.416 | 0.411 | 0.419 | 0.418 |
| MgO + CaO + SrO + BaO | 4.872 | 4.873 | 4.821 | 4.908 | 4.905 |
| MgO + CaO + SrO + BaO + ZnO | 5.426 | 5.426 | 5.368 | 5.465 | 5.462 |
| SiO₂ + B₂O₃ | 14.03 | 14.03 | 13.88 | 14.13 | 14.12 |
| SiO₂/(SiO₂ + B₂O₃) | 0.625 | 0.625 | 0.625 | 0.625 | 0.625 |
| (MgO + CaO + SrO + BaO)/(SiO₂ + B₂O₃) | 0.347 | 0.347 | 0.347 | 0.347 | 0.347 |
| (MgO + CaO + SrO + BaO + ZnO)/(SiO₂ + B₂O₃) | 0.387 | 0.387 | 0.387 | 0.387 | 0.387 |
| Nb₂O₅ + TiO₂ + ZrO₂ + WO₃ | 34.33 | 35.41 | 36.10 | 34.58 | 34.56 |
| (Nb₂O₅ + TiO₂ + ZrO₂ + WO₃)/(SiO₂ + B₂O₃) | 2.447 | 2.524 | 2.600 | 2.447 | 2.447 |
| La₂O₃ + Gd₂O₃ + Y₂O₃ | 44.90 | 44.72 | 44.24 | 45.40 | 45.44 |
| (La₂O₃ + Gd₂O₃ + Y₂O₃)/(SiO₂ + B₂O₃) | 3.200 | 3.188 | 3.188 | 3.213 | 3.217 |
| (Gd₂O₃ + Y₂O₃)/La₂O₃ | 0.229 | 0.230 | 0.230 | 0.215 | 0.236 |
| (MgO + CaO + SrO + BaO + ZnO)/(La₂O₃ + Gd₂O₃ + Y₂O₃) | 0.121 | 0.121 | 0.121 | 0.120 | 0.120 |
| (MgO + CaO + SrO + BaO + ZnO)/(Nb₂O₅ + TiO₂ + ZrO₂ + WO₃) | 0.158 | 0.153 | 0.149 | 0.158 | 0.158 |
| (La₂O₃ + Gd₂O₃ + Y₂O₃)/(Nb₂O₅ + TiO₂ + ZrO₂ + WO₃) | 1.308 | 1.263 | 1.226 | 1.313 | 1.315 |
| (Nb₂O₅ + TiO₂)/SiO₂ | 3.261 | 3.384 | 3.506 | 3.261 | 3.261 |
| (Nb₂O₅ + TiO₂)/(SiO₂ + B₂O₃) | 2.040 | 2.116 | 2.193 | 2.040 | 2.040 |
| Specific gravity | 4.80 | 4.82 | 4.84 | 4.83 | 4.84 |
| Refractive index (nd) | 1.99865 | 2.00188 | 2.00073 | 2.00324 | 2.0032 |
| Abbe's number (νd) | 27.09 | 27.44 | 27.84 | 27.06 | 27.03 |
| Glass transition temperature Tg (° C.) | 733 | 695 | 695 | 699 | 699 |
| Surface devitrified layer(rank) | A | A | A | A | A |

TABLE 7

| Sample No. (mass %) | 31 | 32 | 33 | 34 | 35 |
|---|---|---|---|---|---|
| Al₂O₃ | 0.00 | 0.00 | 0.00 | 0.00 | 0.00 |
| SiO₂ | 8.87 | 8.70 | 8.83 | 9.43 | 8.86 |
| B₂O₃ | 5.31 | 5.21 | 5.29 | 5.28 | 5.30 |
| Li₂O | 0.42 | 0.41 | 0.57 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 3.68 | 1.24 | 1.26 | 1.83 | 1.84 |
| SrO | 0.41 | 0.41 | 0.41 | 0.41 | 0.41 |
| BaO | 0.83 | 0.82 | 0.83 | 0.83 | 0.83 |
| ZnO | 0.56 | 3.17 | 3.22 | 3.21 | 3.22 |
| La₂O₃ | 38.60 | 37.68 | 36.59 | 36.51 | 36.69 |
| Gd₂O₃ | 6.21 | 7.92 | 8.04 | 8.02 | 6.21 |
| Y₂O₃ | 0.39 | 0.39 | 0.39 | 0.39 | 1.55 |
| ZrO₂ | 5.78 | 5.67 | 5.75 | 5.74 | 5.77 |
| Nb₂O₅ | 13.61 | 13.35 | 13.55 | 13.53 | 13.59 |
| TiO₂ | 15.32 | 15.03 | 15.26 | 14.41 | 15.30 |
| WO₃ | 0.00 | 0.00 | 0.00 | 0.00 | 0.00 |
| Total | 100 | 100 | 100 | 100 | 100 |
| Sb₂O₃ | 0 | 0 | 0 | 0 | 0 |
| R₂O | 0.420 | 0.412 | 0.571 | 0.417 | 0.419 |
| MgO + CaO + SrO + BaO | 4.926 | 2.464 | 2.501 | 3.067 | 3.082 |
| MgO + CaO + SrO + BaO + ZnO | 5.485 | 5.632 | 5.717 | 6.276 | 6.307 |
| SiO₂ + B₂O₃ | 14.18 | 13.91 | 14.12 | 14.71 | 14.16 |
| SiO₂/(SiO₂ + B₂O₃) | 0.625 | 0.625 | 0.625 | 0.641 | 0.625 |
| (MgO + CaO + SrO + BaO)/(SiO₂ + B₂O₃) | 0.347 | 0.177 | 0.177 | 0.209 | 0.218 |
| (MgO + CaO + SrO + BaO + ZnO)/(SiO₂ + B₂O₃) | 0.387 | 0.405 | 0.405 | 0.427 | 0.445 |
| Nb₂O₅ + TiO₂ + ZrO₂ + WO₃ | 34.71 | 34.05 | 34.57 | 33.68 | 34.66 |
| (Nb₂O₅ + TiO₂ + ZrO₂ + WO₃)/(SiO₂ + B₂O₃) | 2.447 | 2.447 | 2.447 | 2.290 | 2.447 |
| La₂O₃ + Gd₂O₃ + Y₂O₃ | 45.20 | 45.99 | 45.02 | 44.92 | 44.45 |
| (La₂O₃ + Gd₂O₃ + Y₂O₃)/(SiO₂ + B₂O₃) | 3.187 | 3.305 | 3.188 | 3.055 | 3.138 |
| (Gd₂O₃ + Y₂O₃)/La₂O₃ | 0.171 | 0.220 | 0.230 | 0.230 | 0.211 |
| (MgO + CaO + SrO + BaO + ZnO)/(La₂O₃ + Gd₂O₃ + Y₂O₃) | 0.121 | 0.122 | 0.127 | 0.140 | 0.142 |
| (MgO + CaO + SrO + BaO + ZnO)/(Nb₂O₅ + TiO₂ + ZrO₂ + WO₃) | 0.158 | 0.165 | 0.165 | 0.186 | 0.182 |
| (La₂O₃ + Gd₂O₃ + Y₂O₃)/(Nb₂O₅ + TiO₂ + ZrO₂ + WO₃) | 1.302 | 1.351 | 1.303 | 1.334 | 1.282 |
| (Nb₂O₅ + TiO₂)/SiO₂ | 3.261 | 3.261 | 3.261 | 2.963 | 3.261 |
| (Nb₂O₅ + TiO₂)/(SiO₂ + B₂O₃) | 2.040 | 2.040 | 2.040 | 1.900 | 2.040 |
| Specific gravity | 4.82 | 4.92 | 4.89 | 4.80 | 4.88 |
| Refractive index (nd) | 2.00305 | 2.01284 | 2.01088 | 2.00001 | 2.00923 |
| Abbe's number (νd) | 27.04 | 26.8 | 26.65 | 27.2 | 26.78 |
| Glass transition temperature Tg (° C.) | 693 | 686 | 680 | 687 | 682 |
| Surface devitrified layer(rank) | A | A | A | A | A |

TABLE 8

| Sample No. (mass %) | 36 | 37 | 38 | 39 | 40 |
|---|---|---|---|---|---|
| Al₂O₃ | 0.00 | 0.00 | 0.00 | 0.00 | 0.00 |
| SiO₂ | 8.92 | 8.71 | 8.63 | 8.72 | 8.71 |
| B₂O₃ | 5.34 | 5.22 | 5.17 | 5.22 | 5.21 |
| Li₂O | 0.42 | 0.41 | 0.41 | 0.41 | 0.41 |
| Na₂O | 0.00 | 0.00 | 0.00 | 0.00 | 0.00 |
| K₂O | 0.00 | 0.00 | 0.00 | 0.00 | 0.00 |
| CaO | 1.85 | 1.24 | 0.67 | 1.81 | 1.80 |
| SrO | 0.42 | 0.41 | 0.40 | 0.41 | 0.41 |
| BaO | 0.84 | 2.36 | 3.87 | 0.82 | 0.82 |
| ZnO | 3.25 | 3.17 | 3.14 | 3.18 | 3.17 |
| La₂O₃ | 36.95 | 36.08 | 35.73 | 37.78 | 36.07 |
| Gd₂O₃ | 4.38 | 7.93 | 7.85 | 7.94 | 9.75 |
| Y₂O₃ | 2.72 | 0.39 | 0.38 | 0.39 | 0.39 |
| ZrO₂ | 5.81 | 5.67 | 5.62 | 5.68 | 5.67 |
| Nb₂O₅ | 13.69 | 13.37 | 13.24 | 13.38 | 13.36 |
| TiO₂ | 15.41 | 15.04 | 14.90 | 14.26 | 14.23 |
| WO₃ | 0.00 | 0.00 | 0.00 | 0.00 | 0.00 |
| Total | 100 | 100 | 100 | 100 | 100 |
| Sb₂O₃ | 0 | 0 | 0 | 0 | 0 |
| R₂O | 0.422 | 0.410 | 0.408 | 0.413 | 0.412 |
| MgO + CaO + SrO + BaO | 3.104 | 4.010 | 4.940 | 3.035 | 3.030 |
| MgO + CaO + SrO + BaO + ZnO | 6.351 | 7.180 | 8.080 | 6.211 | 6.199 |
| SiO₂ + B₂O₃ | 14.26 | 13.93 | 13.79 | 13.95 | 13.92 |
| SiO₂/(SiO₂ + B₂O₃) | 0.625 | 0.625 | 0.625 | 0.625 | 0.625 |
| (MgO + CaO + SrO + BaO)/(SiO₂ + B₂O₃) | 0.218 | 0.288 | 0.358 | 0.218 | 0.218 |
| (MgO + CaO + SrO + BaO + ZnO)/(SiO₂ + B₂O₃) | 0.445 | 0.515 | 0.586 | 0.445 | 0.445 |
| Nb₂O₅ + TiO₂ + ZrO₂ + WO₃ | 34.91 | 34.08 | 33.75 | 33.33 | 33.27 |
| (Nb₂O₅ + TiO₂ + ZrO₂ + WO₃)/(SiO₂ + B₂O₃) | 2.447 | 2.447 | 2.447 | 2.389 | 2.389 |
| La₂O₃ + Gd₂O₃ + Y₂O₃ | 44.06 | 44.40 | 43.96 | 46.10 | 46.20 |
| (La₂O₃ + Gd₂O₃ + Y₂O₃)/(SiO₂ + B₂O₃) | 3.089 | 3.187 | 3.188 | 3.305 | 3.318 |
| (Gd₂O₃ + Y₂O₃)/La₂O₃ | 0.192 | 0.231 | 0.230 | 0.220 | 0.281 |
| (MgO + CaO + SrO + BaO + ZnO)/(La₂O₃ + Gd₂O₃ + Y₂O₃) | 0.144 | 0.162 | 0.184 | 0.135 | 0.134 |
| (MgO + CaO + SrO + BaO + ZnO)/(Nb₂O₅ + TiO₂ + ZrO₂ + WO₃) | 0.182 | 0.211 | 0.239 | 0.186 | 0.186 |
| (La₂O₃ + Gd₂O₃ + Y₂O₃)/(Nb₂O₅ + TiO₂ + ZrO₂ + WO₃) | 1.262 | 1.303 | 1.303 | 1.383 | 1.389 |
| (Nb₂O₅ + TiO₂)/SiO₂ | 3.261 | 3.262 | 3.261 | 3.169 | 3.169 |
| (Nb₂O₅ + TiO₂)/(SiO₂ + B₂O₃) | 2.040 | 2.039 | 2.040 | 1.982 | 1.982 |
| Specific gravity | 4.92 | 4.91 | 4.93 | 4.92 | 4.93 |
| Refractive index (nd) | 2.00836 | 2.00948 | 2.00815 | 2.00598 | 2.00578 |
| Abbe's number (νd) | 26.79 | 26.8 | 26.74 | 27.25 | 27.23 |
| Glass transition temperature Tg (° C.) | 684 | 683 | 687 | 682 | 685 |
| Surface devitrified layer(rank) | A | A | A | A | A |

TABLE 9

| Sample No. (mass %) | 41 | 42 | 43 | 44 | 45 |
|---|---|---|---|---|---|
| Al₂O₃ | 0.00 | 0.00 | 0.00 | 0.00 | 0.00 |
| SiO₂ | 8.77 | 8.76 | 8.81 | 8.76 | 8.71 |
| B₂O₃ | 5.25 | 5.24 | 5.63 | 5.60 | 5.57 |
| Li₂O | 0.42 | 0.41 | 0.42 | 0.41 | 0.41 |
| Na₂O | 0.00 | 0.00 | 0.00 | 0.00 | 0.00 |
| K₂O | 0.00 | 0.00 | 0.00 | 0.00 | 0.00 |
| CaO | 1.82 | 1.81 | 1.82 | 1.82 | 1.81 |
| SrO | 0.41 | 0.41 | 0.41 | 0.41 | 0.41 |
| BaO | 0.82 | 0.82 | 0.83 | 0.82 | 0.82 |
| ZnO | 3.19 | 3.19 | 3.21 | 3.19 | 3.17 |
| La₂O₃ | 36.32 | 36.28 | 36.48 | 36.29 | 36.09 |
| Gd₂O₃ | 7.98 | 7.97 | 8.01 | 7.97 | 7.93 |
| Y₂O₃ | 1.53 | 0.39 | 1.54 | 1.53 | 1.52 |
| ZrO₂ | 5.71 | 6.95 | 5.74 | 5.71 | 5.68 |
| Nb₂O₅ | 13.45 | 13.44 | 13.51 | 14.79 | 16.05 |
| TiO₂ | 14.33 | 14.32 | 13.59 | 12.70 | 11.83 |
| WO₃ | 0.00 | 0.00 | 0.00 | 0.00 | 0.00 |
| Total | 100 | 100 | 100 | 100 | 100 |
| Sb₂O₃ | 0 | 0 | 0 | 0 | 0 |
| R₂O | 0.415 | 0.415 | 0.417 | 0.415 | 0.413 |
| MgO + CaO + SrO + BaO | 3.051 | 3.047 | 3.065 | 3.048 | 3.032 |
| MgO + CaO + SrO + BaO + ZnO | 6.242 | 6.236 | 6.271 | 6.237 | 6.204 |
| SiO₂ + B₂O₃ | 14.02 | 14.00 | 14.44 | 14.36 | 14.28 |
| SiO₂/(SiO₂ + B₂O₃) | 0.625 | 0.625 | 0.610 | 0.610 | 0.610 |
| (MgO + CaO + SrO + BaO)/(SiO₂ + B₂O₃) | 0.218 | 0.218 | 0.212 | 0.212 | 0.212 |
| (MgO + CaO + SrO + BaO + ZnO)/(SiO₂ + B₂O₃) | 0.445 | 0.445 | 0.434 | 0.434 | 0.434 |
| Nb₂O₅ + TiO₂ + ZrO₂ + WO₃ | 33.50 | 34.71 | 32.84 | 33.20 | 33.55 |
| (Nb₂O₅ + TiO₂ + ZrO₂ + WO₃)/(SiO₂ + B₂O₃) | 2.389 | 2.479 | 2.275 | 2.312 | 2.349 |
| La₂O₃ + Gd₂O₃ + Y₂O₃ | 45.83 | 44.64 | 46.04 | 45.79 | 45.55 |
| (La₂O₃ + Gd₂O₃ + Y₂O₃)/(SiO₂ + B₂O₃) | 3.269 | 3.188 | 3.189 | 3.189 | 3.189 |
| (Gd₂O₃ + Y₂O₃)/La₂O₃ | 0.262 | 0.230 | 0.262 | 0.262 | 0.262 |
| (MgO + CaO + SrO + BaO + ZnO)/(La₂O₃ + Gd₂O₃ + Y₂O₃) | 0.136 | 0.140 | 0.136 | 0.136 | 0.136 |
| (MgO + CaO + SrO + BaO + ZnO)/(Nb₂O₅ + TiO₂ + ZrO₂ + WO₃) | 0.186 | 0.180 | 0.191 | 0.188 | 0.185 |
| (La₂O₃ + Gd₂O₃ + Y₂O₃)/(Nb₂O₅ + TiO₂ + ZrO₂ + WO₃) | 1.368 | 1.286 | 1.402 | 1.379 | 1.357 |
| (Nb₂O₅ + TiO₂)/SiO₂ | 3.169 | 3.169 | 3.077 | 3.138 | 3.199 |
| (Nb₂O₅ + TiO₂)/(SiO₂ + B₂O₃) | 1.982 | 1.982 | 1.877 | 1.915 | 1.952 |
| Specific gravity | 4.90 | 4.89 | 4.89 | 4.93 | 4.91 |
| Refractive index (nd) | 2.00499 | 2.00787 | 1.99712 | 1.99656 | 1.9961 |
| Abbe's number (νd) | 27.24 | 27.07 | 27.68 | 27.28 | 26.88 |
| Glass transition temperature Tg (° C.) | 686 | 683 | 687 | 684 | 680 |
| Surface devitrified layer(rank) | A | A | A | A | A |

TABLE 10

| Sample No. (mass %) | 46 | 47 | 48 | 49 | 50 |
|---|---|---|---|---|---|
| Al₂O₃ | 0.00 | 0.00 | 0.00 | 0.00 | 0.00 |
| SiO₂ | 8.65 | 8.84 | 8.88 | 7.39 | 8.82 |
| B₂O₃ | 5.53 | 5.65 | 6.03 | 6.97 | 5.99 |
| Li₂O | 0.41 | 0.42 | 0.42 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 0.11 | 1.83 | 1.84 | 1.85 | 0.40 |
| SrO | 0.40 | 0.41 | 0.42 | 0.42 | 0.41 |
| BaO | 0.81 | 0.83 | 0.83 | 0.84 | 0.83 |
| ZnO | 5.59 | 3.22 | 3.23 | 3.25 | 5.28 |
| La₂O₃ | 35.82 | 36.61 | 36.78 | 37.01 | 36.54 |
| Gd₂O₃ | 7.87 | 8.04 | 8.08 | 8.13 | 8.03 |
| Y₂O₃ | 1.51 | 0.39 | 0.39 | 0.40 | 0.39 |
| ZrO₂ | 5.63 | 5.76 | 5.78 | 5.82 | 5.75 |
| Nb₂O₅ | 15.92 | 13.56 | 13.62 | 13.71 | 13.53 |
| TiO₂ | 11.74 | 14.45 | 13.69 | 13.78 | 13.61 |
| WO₃ | 0.00 | 0.00 | 0.00 | 0.00 | 0.00 |
| Total | 100 | 100 | 100 | 100 | 100 |
| Sb₂O₃ | 0 | 0 | 0 | 0 | 0 |
| R₂O | 0.410 | 0.418 | 0.420 | 0.423 | 0.418 |
| MgO + CaO + SrO + BaO | 1.328 | 3.075 | 3.089 | 3.109 | 1.640 |
| MgO + CaO + SrO + BaO + ZnO | 6.915 | 6.292 | 6.321 | 6.362 | 6.925 |
| SiO₂ + B₂O₃ | 14.17 | 14.49 | 14.91 | 14.35 | 14.81 |
| SiO₂/(SiO₂ + B₂O₃) | 0.610 | 0.610 | 0.596 | 0.515 | 0.596 |
| (MgO + CaO + SrO + BaO)/(SiO₂ + B₂O₃) | 0.094 | 0.212 | 0.207 | 0.217 | 0.111 |
| (MgO + CaO + SrO + BaO + ZnO)/(SiO₂ + B₂O₃) | 0.488 | 0.434 | 0.424 | 0.443 | 0.467 |
| Nb₂O₅ + TiO₂ + ZrO₂ + WO₃ | 33.30 | 33.76 | 33.10 | 33.32 | 32.89 |
| (Nb₂O₅ + TiO₂ + ZrO₂ + WO₃)/(SiO₂ + B₂O₃) | 2.349 | 2.331 | 2.220 | 2.321 | 2.220 |
| La₂O₃ + Gd₂O₃ + Y₂O₃ | 45.20 | 45.04 | 45.25 | 45.54 | 44.96 |
| (La₂O₃ + Gd₂O₃ + Y₂O₃)/(SiO₂ + B₂O₃) | 3.189 | 3.109 | 3.035 | 3.173 | 3.035 |
| (Gd₂O₃ + Y₂O₃)/La₂O₃ | 0.262 | 0.230 | 0.230 | 0.230 | 0.230 |
| (MgO + CaO + SrO + BaO + ZnO)/(La₂O₃ + Gd₂O₃ + Y₂O₃) | 0.153 | 0.140 | 0.140 | 0.140 | 0.154 |
| (MgO + CaO + SrO + BaO + ZnO)/(Nb₂O₅ + TiO₂ + ZrO₂ + WO₃) | 0.208 | 0.186 | 0.191 | 0.191 | 0.211 |
| (La₂O₃ + Gd₂O₃ + Y₂O₃)/(Nb₂O₅ + TiO₂ + ZrO₂ + WO₃) | 1.357 | 1.334 | 1.367 | 1.367 | 1.367 |
| (Nb₂O₅ + TiO₂)/SiO₂ | 3.199 | 3.169 | 3.077 | 3.722 | 3.077 |
| (Nb₂O₅ + TiO₂)/(SiO₂ + B₂O₃) | 1.952 | 1.933 | 1.832 | 1.915 | 1.832 |
| Specific gravity | 4.97 | 4.86 | 4.86 | 4.89 | 4.92 |
| Refractive index (nd) | 2.00179 | 2.00237 | 1.99486 | 1.99991 | 1.99941 |
| Abbe's number (νd) | 26.7 | 27.2 | 27.6 | 27.42 | 27.45 |
| Glass transition temperature Tg (° C.) | 671 | 671 | 672 | 670 | 673 |
| Surface devitrified layer(rank) | A | A | A | A | A |

TABLE 11

| Sample No. (mass %) | 51 | 52 | 53 | 54 | 55 |
|---|---|---|---|---|---|
| Al₂O₃ | 0.00 | 0.00 | 0.00 | 0.00 | 0.00 |
| SiO₂ | 7.27 | 7.16 | 7.35 | 7.31 | 8.85 |
| B₂O₃ | 6.86 | 6.76 | 6.93 | 6.89 | 6.01 |
| Li₂O | 0.42 | 0.41 | 0.42 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 1.82 | 1.80 | 1.84 | 1.83 | 0.69 |
| SrO | 0.41 | 0.41 | 0.42 | 0.41 | 0.41 |
| BaO | 0.83 | 0.81 | 0.84 | 0.83 | 0.83 |
| ZnO | 3.20 | 3.15 | 3.24 | 3.22 | 5.30 |
| La₂O₃ | 36.44 | 35.89 | 36.81 | 36.61 | 36.66 |
| Gd₂O₃ | 8.01 | 7.88 | 8.09 | 8.04 | 8.05 |
| Y₂O₃ | 0.39 | 0.38 | 0.39 | 0.39 | 0.39 |
| ZrO₂ | 5.73 | 5.64 | 5.79 | 5.76 | 5.14 |
| Nb₂O₅ | 13.50 | 13.29 | 15.00 | 16.28 | 13.58 |
| TiO₂ | 12.76 | 11.77 | 12.89 | 12.00 | 13.65 |
| WO₃ | 2.36 | 4.64 | 0.00 | 0.00 | 0.00 |
| Total | 100 | 100 | 100 | 100 | 100 |
| Sb₂O₃ | 0 | 0 | 0 | 0 | 0 |
| R₂O | 0.417 | 0.410 | 0.421 | 0.419 | 0.419 |
| MgO + CaO + SrO + BaO | 3.061 | 3.015 | 3.092 | 3.076 | 1.933 |
| MgO + CaO + SrO + BaO + ZnO | 6.264 | 6.169 | 6.328 | 6.293 | 7.236 |
| SiO₂ + B₂O₃ | 14.13 | 13.92 | 14.28 | 14.20 | 14.86 |
| SiO₂/(SiO₂ + B₂O₃) | 0.515 | 0.515 | 0.515 | 0.515 | 0.596 |
| (MgO + CaO + SrO + BaO)/(SiO₂ + B₂O₃) | 0.217 | 0.217 | 0.217 | 0.217 | 0.130 |
| (MgO + CaO + SrO + BaO + ZnO)/(SiO₂ + B₂O₃) | 0.443 | 0.443 | 0.443 | 0.443 | 0.487 |
| Nb₂O₅ + TiO₂ + ZrO₂ + WO₃ | 34.35 | 35.35 | 33.68 | 34.04 | 32.37 |
| (Nb₂O₅ + TiO₂ + ZrO₂ + WO₃)/(SiO₂ + B₂O₃) | 2.430 | 2.540 | 2.359 | 2.397 | 2.178 |
| La₂O₃ + Gd₂O₃ + Y₂O₃ | 44.84 | 44.16 | 45.30 | 45.05 | 45.11 |
| (La₂O₃ + Gd₂O₃ + Y₂O₃)/(SiO₂ + B₂O₃) | 3.173 | 3.173 | 3.173 | 3.173 | 3.035 |
| (Gd₂O₃ + Y₂O₃)/La₂O₃ | 0.230 | 0.230 | 0.230 | 0.230 | 0.230 |
| (MgO + CaO + SrO + BaO + ZnO)/(La₂O₃ + Gd₂O₃ + Y₂O₃) | 0.140 | 0.140 | 0.140 | 0.140 | 0.160 |
| (MgO + CaO + SrO + BaO + ZnO)/(Nb₂O₅ + TiO₂ + ZrO₂ + WO₃) | 0.182 | 0.175 | 0.188 | 0.185 | 0.224 |
| (La₂O₃ + Gd₂O₃ + Y₂O₃)/(Nb₂O₅ + TiO₂ + ZrO₂ + WO₃) | 1.306 | 1.249 | 1.345 | 1.323 | 1.394 |
| (Nb₂O₅ + TiO₂)/SiO₂ | 3.611 | 3.499 | 3.797 | 3.871 | 3.077 |
| (Nb₂O₅ + TiO₂)/(SiO₂ + B₂O₃) | 1.858 | 1.801 | 1.954 | 1.992 | 1.832 |
| Specific gravity | 4.97 | 4.96 | 4.91 | 4.91 | 4.91 |
| Refractive index (nd) | 1.99808 | 1.99696 | 1.9988 | 1.99929 | 1.99685 |
| Abbe's number (νd) | 27.47 | 27.53 | 27.62 | 27.02 | 27.45 |
| Glass transition temperature Tg (° C.) | 671 | 666 | 674 | 672 | 670 |
| Surface devitrified layer(rank) | A | A | A | A | A |

TABLE 12

| Sample No. (mass %) | 56 | 57 | 58 | 59 | 60 |
|---|---|---|---|---|---|
| Al₂O₃ | 0.00 | 0.00 | 0.00 | 0.00 | 0.00 |
| SiO₂ | 8.84 | 8.80 | 8.83 | 8.25 | 7.65 |
| B₂O₃ | 6.00 | 5.98 | 5.99 | 6.38 | 6.75 |
| Li₂O | 0.42 | 0.42 | 0.42 | 0.42 | 0.42 |
| Na₂O | 0.00 | 0.00 | 0.00 | 0.00 | 0.00 |
| K₂O | 0.00 | 0.00 | 0.00 | 0.00 | 0.00 |
| CaO | 0.40 | 0.40 | 0.40 | 0.40 | 0.40 |
| SrO | 0.41 | 0.41 | 0.41 | 0.41 | 0.42 |
| BaO | 0.83 | 0.83 | 0.83 | 0.83 | 0.84 |
| ZnO | 5.71 | 5.27 | 5.29 | 5.73 | 5.74 |
| La₂O₃ | 36.62 | 37.29 | 36.56 | 36.71 | 36.81 |
| Gd₂O₃ | 8.04 | 8.01 | 8.03 | 8.06 | 8.09 |
| Y₂O₃ | 0.39 | 0.39 | 0.97 | 0.39 | 0.39 |
| ZrO₂ | 5.13 | 5.11 | 5.12 | 5.15 | 5.16 |
| Nb₂O₅ | 13.56 | 13.51 | 13.54 | 13.60 | 13.63 |
| TiO₂ | 13.64 | 13.58 | 13.61 | 13.67 | 13.71 |
| WO₃ | 0.00 | 0.00 | 0.00 | 0.00 | 0.00 |
| Total | 100 | 100 | 100 | 100 | 100 |
| Sb₂O₃ | 0 | 0 | 0 | 0 | 0 |
| R₂O | 0.419 | 0.417 | 0.418 | 0.420 | 0.421 |
| MgO + CaO + SrO + BaO | 1.644 | 1.637 | 1.641 | 1.648 | 1.652 |
| MgO + CaO + SrO + BaO + ZnO | 7.356 | 6.911 | 6.929 | 7.375 | 7.394 |
| SiO₂ + B₂O₃ | 14.85 | 14.78 | 14.82 | 14.62 | 14.40 |
| SiO₂/(SiO₂ + B₂O₃) | 0.596 | 0.596 | 0.596 | 0.564 | 0.531 |
| (MgO + CaO + SrO + BaO)/(SiO₂ + B₂O₃) | 0.111 | 0.111 | 0.111 | 0.113 | 0.115 |
| (MgO + CaO + SrO + BaO + ZnO)/(SiO₂ + B₂O₃) | 0.495 | 0.467 | 0.467 | 0.504 | 0.513 |
| Nb₂O₅ + TiO₂ + ZrO₂ + WO₃ | 32.33 | 32.19 | 32.28 | 32.42 | 32.50 |
| (Nb₂O₅ + TiO₂ + ZrO₂ + WO₃)/(SiO₂ + B₂O₃) | 2.178 | 2.178 | 2.178 | 2.216 | 2.256 |
| La₂O₃ + Gd₂O₃ + Y₂O₃ | 45.05 | 45.69 | 45.56 | 45.17 | 45.29 |
| (La₂O₃ + Gd₂O₃ + Y₂O₃)/(SiO₂ + B₂O₃) | 3.035 | 3.091 | 3.074 | 3.089 | 3.144 |
| (Gd₂O₃ + Y₂O₃)/La₂O₃ | 0.230 | 0.225 | 0.246 | 0.230 | 0.230 |
| (MgO + CaO + SrO + BaO + ZnO)/(La₂O₃ + Gd₂O₃ + Y₂O₃) | 0.163 | 0.151 | 0.152 | 0.163 | 0.163 |
| (MgO + CaO + SrO + BaO + ZnO)/(Nb₂O₅ + TiO₂ + ZrO₂ + WO₃) | 0.228 | 0.215 | 0.215 | 0.228 | 0.228 |
| (La₂O₃ + Gd₂O₃ + Y₂O₃)/(Nb₂O₅ + TiO₂ + ZrO₂ + WO₃) | 1.394 | 1.419 | 1.411 | 1.393 | 1.393 |
| (Nb₂O₅ + TiO₂)/SiO₂ | 3.077 | 3.077 | 3.077 | 3.306 | 3.572 |
| (Nb₂O₅ + TiO₂)/(SiO₂ + B₂O₃) | 1.832 | 1.832 | 1.832 | 1.865 | 1.898 |
| Specific gravity | 4.92 | 4.93 | 4.92 | 4.91 | 4.92 |
| Refractive index (nd) | 1.9979 | 1.99833 | 1.9979 | 2.00022 | 2.00233 |
| Abbe's number (νd) | 27.38 | 27.46 | 27.44 | 27.35 | 27.27 |
| Glass transition temperature Tg (° C.) | 670 | 673 | 667 | 668 | 662 |
| Surface devitrified layer(rank) | A | A | A | A | A |

TABLE 13

| Sample No. (mass %) | 61 | 62 | 63 | 64 |
|---|---|---|---|---|
| Al₂O₃ | 0.00 | 0.52 | 0.00 | 0.00 |
| SiO₂ | 8.27 | 8.23 | 7.61 | 7.57 |
| B₂O₃ | 6.03 | 6.01 | 6.71 | 6.68 |
| Li₂O | 0.57 | 0.42 | 0.42 | 0.42 |
| Na₂O | 0.00 | 0.00 | 0.00 | 0.00 |
| K₂O | 0.00 | 0.00 | 0.00 | 0.00 |
| CaO | 0.40 | 0.40 | 0.40 | 0.40 |
| SrO | 0.42 | 0.41 | 0.41 | 0.41 |
| BaO | 0.83 | 0.83 | 0.83 | 0.83 |
| ZnO | 5.74 | 5.72 | 5.71 | 5.68 |
| La₂O₃ | 36.79 | 36.65 | 36.61 | 36.41 |
| Gd₂O₃ | 8.08 | 8.05 | 8.04 | 8.00 |
| Y₂O₃ | 0.39 | 0.39 | 0.39 | 0.39 |
| ZrO₂ | 5.16 | 5.14 | 5.13 | 5.11 |
| Nb₂O₅ | 13.63 | 13.58 | 14.92 | 16.19 |
| TiO₂ | 13.70 | 13.65 | 12.82 | 11.94 |
| WO₃ | 0.00 | 0.00 | 0.00 | 0.00 |
| Total | 100 | 100 | 100 | 100 |
| Sb₂O₃ | 0 | 0 | 0 | 0 |
| R₂O | 0.574 | 0.419 | 0.419 | 0.416 |
| MgO + CaO + SrO + BaO | 1.651 | 1.645 | 1.643 | 1.635 |
| MgO + CaO + SrO + BaO + ZnO | 7.390 | 7.362 | 7.354 | 7.314 |
| SiO₂ + B₂O₃ | 14.30 | 14.24 | 14.33 | 14.25 |
| SiO₂/(SiO₂ + B₂O₃) | 0.578 | 0.578 | 0.531 | 0.531 |
| (MgO + CaO + SrO + BaO)/(SiO₂ + B₂O₃) | 0.116 | 0.116 | 0.115 | 0.115 |
| (MgO + CaO + SrO + BaO + ZnO)/(SiO₂ + B₂O₃) | 0.517 | 0.517 | 0.513 | 0.513 |
| Nb₂O₅ + TiO₂ + ZrO₂ + WO₃ | 32.48 | 32.36 | 32.87 | 33.23 |
| (Nb₂O₅ + TiO₂ + ZrO₂ + WO₃)/(SiO₂ + B₂O₃) | 2.272 | 2.272 | 2.294 | 2.332 |
| La₂O₃ + Gd₂O₃ + Y₂O₃ | 45.26 | 45.09 | 45.04 | 44.80 |
| (La₂O₃ + Gd₂O₃ + Y₂O₃)/(SiO₂ + B₂O₃) | 3.166 | 3.166 | 3.144 | 3.144 |
| (Gd₂O₃ + Y₂O₃)/La₂O₃ | 0.230 | 0.230 | 0.230 | 0.230 |
| (MgO + CaO + SrO + BaO + ZnO)/(La₂O₃ + Gd₂O₃ + Y₂O₃) | 0.163 | 0.163 | 0.163 | 0.163 |
| (MgO + CaO + SrO + BaO + ZnO)/(Nb₂O₅ + TiO₂ + ZrO₂ + WO₃) | 0.228 | 0.228 | 0.224 | 0.220 |
| (La₂O₃ + Gd₂O₃ + Y₂O₃)/(Nb₂O₅ + TiO₂ + ZrO₂ + WO₃) | 1.393 | 1.393 | 1.370 | 1.348 |
| (Nb₂O₅ + TiO₂)/SiO₂ | 3.306 | 3.306 | 3.644 | 3.715 |
| (Nb₂O₅ + TiO₂)/(SiO₂ + B₂O₃) | 1.911 | 1.911 | 1.936 | 1.974 |
| Specific gravity | 4.94 | 4.91 | 4.94 | 4.93 |
| Refractive index (nd) | 2.00188 | 1.99667 | 2.00174 | 2.00111 |
| Abbe's number (νd) | 27.28 | 27.48 | 27.39 | 27.47 |
| Glass transition temperature Tg (° C.) | 666 | 670 | 663 | 662 |
| Surface devitrified layer(rank) | A | A | A | A |

TABLE 14

| Sample No. (mass %) | 65 | 66 | Comp. Ex. 1 |
|---|---|---|---|
| Al₂O₃ | 0.00 | 0.00 | 0.00 |
| SiO₂ | 7.62 | 7.59 | 6.21 |
| B₂O₃ | 6.72 | 6.69 | 8.16 |
| Li₂O | 0.42 | 0.42 | 0.00 |
| Na₂O | 0.00 | 0.00 | 0.00 |
| K₂O | 0.00 | 0.00 | 0.00 |
| CaO | 0.40 | 0.40 | 0.00 |
| SrO | 0.41 | 0.41 | 0.00 |
| BaO | 0.83 | 0.83 | 0.00 |
| ZnO | 5.72 | 5.69 | 1.61 |
| La₂O₃ | 36.64 | 36.48 | 55.90 |
| Gd₂O₃ | 8.05 | 8.01 | 0.00 |
| Y₂O₃ | 0.39 | 0.39 | 0.28 |
| ZrO₂ | 6.40 | 7.62 | 5.84 |
| Nb₂O₅ | 13.57 | 13.51 | 7.96 |
| TiO₂ | 12.83 | 11.96 | 14.05 |
| WO₃ | 0.00 | 0.00 | 0.00 |
| Total | 100 | 100 | 100 |
| Sb₂O₃ | 0 | 0 | 0 |
| R₂O | 0.419 | 0.417 | 0.000 |
| MgO + CaO + SrO + BaO | 1.645 | 1.638 | 0.000 |
| MgO + CaO + SrO + BaO + ZnO | 7.361 | 7.329 | 1.605 |
| SiO₂ + B₂O₃ | 14.34 | 14.28 | 14.37 |
| SiO₂/(SiO₂ + B₂O₃) | 0.531 | 0.531 | 0.432 |
| (MgO + CaO + SrO + BaO)/(SiO₂ + B₂O₃) | 0.115 | 0.115 | 0.000 |
| (MgO + CaO + SrO + BaO + ZnO)/(SiO₂ + B₂O₃) | 0.513 | 0.513 | 0.112 |
| Nb₂O₅ + TiO₂ + ZrO₂ + WO₃ | 32.80 | 33.10 | 27.84 |
| (Nb₂O₅ + TiO₂ + ZrO₂ + WO₃)/(SiO₂ + B₂O₃) | 2.287 | 2.318 | 1.938 |
| La₂O₃ + Gd₂O₃ + Y₂O₃ | 45.09 | 44.89 | 56.18 |
| (La₂O₃ + Gd₂O₃ + Y₂O₃)/(SiO₂ + B₂O₃) | 3.144 | 3.144 | 3.911 |
| (Gd₂O₃ + Y₂O₃)/La₂O₃ | 0.230 | 0.230 | 0.005 |
| (MgO + CaO + SrO + BaO + ZnO)/(La₂O₃ + Gd₂O₃ + Y₂O₃) | 0.163 | 0.163 | 0.029 |
| (MgO + CaO + SrO + BaO + ZnO)/(Nb₂O₅ + TiO₂ + ZrO₂ + WO₃) | 0.224 | 0.221 | 0.058 |
| (La₂O₃ + Gd₂O₃ + Y₂O₃)/(Nb₂O₅ + TiO₂ + ZrO₂ + WO₃) | 1.375 | 1.356 | 2.018 |
| (Nb₂O₅ + TiO₂)/SiO₂ | 3.465 | 3.358 | 3.543 |
| (Nb₂O₅ + TiO₂)/(SiO₂ + B₂O₃) | 1.841 | 1.784 | 1.532 |
| Specific gravity | 4.96 | 4.97 | 5.03 |
| Refractive index (nd) | 1.99320 | 1.99747 | 2.00349 |
| Abbe's number (νd) | 27.6 | 28.04 | 28.7 |
| Glass transition temperature Tg (° C.) | 666 | 665 | 717 |
| Surface devitrified layer(rank) | A | A | C |

### Example 2

Using the various glasses obtained in Example 1, a glass block (glass gob) for press molding was manufactured. The glass block was heated and softened in the atmosphere, and was press molded in a mold for press molding, thereby manufacturing a lens blank (optical element blank). The manufactured lens blank was taken out from the mold for press molding, and was annealed, and was subjected to machining including polishing, thereby manufacturing spherical lenses comprised of each of various glasses manufactured in Example 1.

### Example 3

The molten glass manufactured in Example 1 was press molded in a desired amount in a mold for press molding, thereby manufacturing a lens blank (optical element blank). The manufactured lens blank was taken out from the mold for press molding, and was annealed, and was subjected to machining including polishing, thereby manufacturing spherical lenses comprised of each of various glasses manufactured in Example 1.

### Example 4

The glass block (optical element blank) manufactured by vitrifying the molten glass manufactured in Example 1 was annealed, and was subjected to machining including polishing, thereby manufacturing spherical lenses comprised of each of various glasses manufactured in Example 1.

Finally, the various aspects described above will be summarized.

[1] An optical glass, having, in terms of glass composition expressed in mass %,

a SiO₂ content of 3.00% or more and 20.00% or less,

a B₂O₃ content of 1.00% or more and 18.00% or less,

a La₂O₃ content of 20.00% or more and 60.00% or less,

a Nb₂O₅ content of 8.80% or more,

a TiO₂ content of 5.00% or more and 20.00% or less,

a total content of MgO, CaO, SrO, BaO, and ZnO (MgO+CaO+SrO+BaO+ZnO) of 2.00% or more,

a mass ratio of a total content of MgO, CaO, SrO, BaO, and ZnO to a total content of SiO₂ and B₂O₃ ((MgO+CaO+SrO+BaO+ZnO)/(SiO₂+B₂O₃)) of 0.300 or more,

a mass ratio of a total content of Nb₂O₅, TiO₂, ZrO₂, and WO₃ to a total content of SiO₂ and B₂O₃ ((Nb₂O₅+TiO₂+ZrO₂+WO₃)/(SiO₂+B₂O₃)) of 1.600 or more,

a mass ratio of a total content of La₂O₃, Gd₂O₃, and Y₂O₃ to a total content of SiO₂ and B₂O₃ ((La₂O₃+Gd₂O₃+Y₂O₃)/(SiO₂+B₂O₃)) of 2.750 or more,

a mass ratio of a total content of MgO, CaO, SrO, BaO, and ZnO to a total content of Nb₂O₅, TiO₂, ZrO₂, and WO₃ ((MgO+CaO+SrO+BaO+ZnO)/(Nb₂O₅+TiO₂+ZrO₂+WO₃)) of 0.290 or less, and

a mass ratio of a total content of Nb₂O₅ and TiO₂ to the total content of SiO₂ and B₂O₃ ((Nb₂O₅+TiO₂)/(SiO₂+B₂O₃)) of 1.400 or more.

[2] The optical glass according to [1], wherein the mass ratio of the SiO₂ content to the total content of SiO₂ and B₂O₃ (SiO₂/(SiO₂+B₂O₃)) is 0.300 or more.

[3] The optical glass according to [1] or [2], wherein the total content of Nb₂O₅, TiO₂, ZrO₂, and WO₃ (Nb₂O₅+TiO₂+ZrO₂+WO₃) is 29.50% or more.

[4] The optical glass according to any one of [1] to [3], wherein the total content of La₂O₃, Gd₂O₃, and Y₂O₃ (La₂O₃+Gd₂O₃+Y₂O₃) is 60.00% or less.

[5] The optical glass according to any one of [1] to [4], wherein the mass ratio of the total content of MgO, CaO, SrO, BaO, and ZnO to the total content of La₂O₃, Gd₂O₃, and Y₂O₃ ((MgO+CaO+SrO+BaO+ZnO)/(La₂O₃+Gd₂O₃+Y₂O₃)) is 0.410 or less.

[6] The optical glass according to any one of [1] to [5], wherein the mass ratio of the total content of Nb₂O₅ and TiO₂ to the SiO₂ content ((Nb₂O₅+TiO₂)/SiO₂) is 2.400 or more.

[7] The optical glass according to any one of [1] to [6], wherein the refractive index nd is 1.95000 or more.

[8] The optical glass according to [1], wherein

the mass ratio of the SiO₂ content to the total content of SiO₂ and B₂O₃ (SiO₂/(SiO₂+B₂O₃)) is 0.300 or more,

the total content of Nb₂O₅, TiO₂, ZrO₂, and WO₃ (Nb₂O₅+TiO₂+ZrO₂+WO₃) is 29.50% or more,

the total content of La₂O₃+Gd₂O₃+Y₂O₃(La₂O₃+Gd₂O₃+Y₂O₃) is 60.00% or less,

the mass ratio of the total content of MgO, CaO, SrO, BaO, and ZnO to the total content of La₂O₃, Gd₂O₃, and Y₂O₃ ((MgO+CaO+SrO+BaO+ZnO)/(La₂O₃+Gd₂O₃+Y₂O₃)) is 0.410 or less,

the mass ratio of the total content of Nb₂O₅ and TiO₂ to the SiO₂ content ((Nb₂O₅+TiO₂)/SiO₂) is 2.400 or more, and

the refractive index nd is 1.95000 or more.

[9] An optical element comprised of the optical glass according to any one of [1] to [8].

It should be considered that the embodiments disclosed this time are illustrative, and are not restrictive in terms of all the points. It is intended that the scope of the present disclosure is shown not by the explanations but by the appended claims, and includes all the changes within the meaning and scope equivalent to the appended claims.

For example, by performing the adjustment of the composition described in the specification on the exemplified glass composition, it is possible to obtain optical glass in accordance with one aspect of the present disclosure.

Further, it is naturally understood that two or more of the matters described as the examples or the preferable scopes in the specification can be arbitrarily combined.

What is claimed is:

1. An optical glass, having, in terms of glass composition expressed in mass %,
a SiO₂ content of 3.00% or more and 20.00% or less,
a B₂O₃ content of 1.00% or more and 18.00% or less,
a La₂O₃ content of 20.00% or more and 60.00% or less,
a Nb₂O₅ content of 8.80% or more,
a TiO₂ content of 5.00% or more and 20.00% or less,
a total content of MgO, CaO, SrO, BaO, and ZnO (MgO+CaO+SrO+BaO+ZnO) of 2.00% or more,
a mass ratio of the total content of MgO, CaO, SrO, BaO, and ZnO to a total content of SiO₂ and B₂O₃ ((MgO+CaO+SrO+BaO+ZnO)/(SiO₂+B₂O₃)) of 0.300 or more,
a mass ratio of a total content of Nb₂O₅, TiO₂, ZrO₂, and WO₃ to the total content of SiO₂ and B₂O₃ ((Nb₂O₅+TiO₂+ZrO₂+WO₃)/(SiO₂+B₂O₃)) of 1.600 or more,
a mass ratio of a total content of La₂O₃, Gd₂O₃, and Y₂O₃ to the total content of SiO₂ and B₂O₃ ((La₂O₃+Gd₂O₃+Y₂O₃)/(SiO₂+B₂O₃)) of 2.750 or more,
a mass ratio of the total content of MgO, CaO, SrO, BaO, and ZnO to the total content of Nb₂O₅, TiO₂, ZrO₂, and WO₃ ((MgO+CaO+SrO+BaO+ZnO)/(Nb₂O₅+TiO₂+ZrO₂+WO₃)) of 0.290 or less, and
a mass ratio of a total content of Nb₂O₅ and TiO₂ to the total content of SiO₂ and B₂O₃ ((Nb₂O₅+TiO₂)/(SiO₂+B₂O₃)) of 1.400 or more.

2. The optical glass according to claim 1,
wherein a mass ratio of the SiO₂ content to the total content of SiO₂ and B₂O₃ (SiO₂/(SiO₂+B₂O₃)) is 0.300 or more.

3. The optical glass according to claim 1,
wherein the total content of Nb₂O₅, TiO₂, ZrO₂, and WO₃ (Nb₂O₅+TiO₂+ZrO₂+WO₃) is 29.50% or more.

4. The optical glass according to claim 1,
wherein the total content of La₂O₃, Gd₂O₃, and Y₂O₃ (La₂O₃+Gd₂O₃+Y₂O₃) is 60.00% or less.

5. The optical glass according to claim 1,
wherein a mass ratio of the total content of MgO, CaO, SrO, BaO, and ZnO to the total content of La₂O₃, Gd₂O₃, and Y₂O₃ ((MgO+CaO+SrO+BaO+ZnO)/(La₂O₃+Gd₂O₃+Y₂O₃)) is 0.410 or less.

6. The optical glass according to claim 1,
wherein a mass ratio of the total content of Nb₂O₅ and TiO₂ to the SiO₂ content ((Nb₂O₅+TiO₂)/SiO₂) is 2.400 or more.

7. The optical glass according to claim 1,
wherein a refractive index nd is 1.95000 or more.

8. The optical glass according to claim 1,
Wherein a mass ratio of the SiO₂ content to the total content of SiO₂ and B₂O₃ (SiO₂/(SiO₂+B₂O₃)) is 0.300 or more,
the total content of Nb₂O₅, TiO₂, ZrO₂, and WO₃ (Nb₂O₅+TiO₂+ZrO₂+WO₃) is 29.50% or more,
the total content of La₂O₃+Gd₂O₃+Y₂O₃ (La₂O₃+Gd₂O₃+Y₂O₃) is 60.00% or less,
a mass ratio of the total content of MgO, CaO, SrO, BaO, and ZnO to the total content of La₂O₃, Gd₂O₃, and Y₂O₃ ((MgO+CaO+SrO+BaO+ZnO)/(La₂O₃+Gd₂O₃+Y₂O₃)) is 0.410 or less,
a mass ratio of the total content of Nb₂O₅ and TiO₂ to the SiO₂ content ((Nb₂O₅+TiO₂)/SiO₂) is 2.400 or more, and
a refractive index nd is 1.95000 or more.

9. An optical element comprised of the optical glass according to claim 1.

10. An optical element comprised of the optical glass according to claim 2.

11. An optical element comprised of the optical glass according to claim 3.

12. An optical element comprised of the optical glass according to claim 4.

13. An optical element comprised of the optical glass according to claim 5.

14. An optical element comprised of the optical glass according to claim 6.

15. An optical element comprised of the optical glass according to claim 7.

16. An optical element comprised of the optical glass according to claim 8.
